(19) United States
(12) Patent Application Publication
(10) Pub. No.: US 2022/0075381 A1
(43) Pub. Date: Mar. 10, 2022

(54) REQUIRED TRANSFER TIME PREDICTION DEVICE AND REQUIRED TRANSFER TIME PREDICTION METHOD

(71) Applicant: SHARP KABUSHIKI KAISHA, Sakai City (JP)

(72) Inventors: THINH NGUYENQUANG, Sakai City (JP); HIROKI OSAWA, Sakai City (JP); MASAHIRO SAKAKIBARA, Sakai City (JP); Hiroshi YAMAUCHI, Sakai City (JP)

(21) Appl. No.: 17/412,946

(22) Filed: Aug. 26, 2021

(30) Foreign Application Priority Data
Sep. 9, 2020 (JP) 2020-151059

(51) Int. Cl. G05D 1/02; G06Q 10/06; G06Q 10/04

(52) U.S. Cl. CPC G05D 1/0217; G05D 1/0287; G05D 2201/0216; G06Q 10/047; G06Q 10/06315

(57) ABSTRACT

An automatic vehicle dispatching system is applied to a factory where manufacturing operation devices reside, and includes an optimization server, a management server, and AGVs. The management server controls transfer of the AGVs and transmits a current transport request received from one of the manufacturing operation devices to the optimization server. The optimization server predicts a future transport request to be issued by each of other manufacturing operation devices using predicted transport request interval patterns, and generates allocation models by allocating AGVs to each transport request in different patterns. The optimization server predicts required transfer times for the allocated AGVs and adds up the required transfer times for each allocation model. The optimization server selects one allocation model having a smallest sum of the required transfer times, generates a transfer instruction for the current transport request based on the selected allocation model, and transmits the instruction to the management server.

### BACKGROUND OF THE INVENTION

### Field of the Invention

The present invention relates to a required transfer time prediction device and a required transfer time prediction method. More particularly, for example, the present invention relates to a required transfer time prediction device and a required transfer time prediction method for predicting a required transfer time for an automatic guided vehicle when the automatic guided vehicle transports an item from one base position to another.

### Description of the Background Art

Japanese Unexamined Patent Application Publication No. 2006-108264 discloses an example of background art. Japanese Unexamined Patent Application Publication No. 2006-108264 discloses an article transporting method including a first transport cart transporting a first transport object from a first transport starting point device to a transport destination device and a second transport cart transporting a second transport object from a second transport starting point device to the transport destination device. In this method, a transport cart expected to arrive at the transport destination device at a specific time determined based on a transport time, which is a period of time required for the transport from the second transport starting point device to the transport destination device, and a time at which the first transport object arrives at the transport destination device is selected as the second transport cart, and the second transport object is delivered by the thus determined second transport cart.

However, in some cases, the actual transport time disagrees with the specific time. The above-described background art does not take into account any actual transport time required for past transport by a transport cart, and therefore the prediction of a required transport time for a transport cart to arrive at a transport destination device is less accurate.

It is therefore a main objective of the present invention to provide a novel required transfer time prediction device and a novel required transfer time prediction method.

It is another objective of the present invention to provide a required transfer time prediction device and a required transfer time prediction method that allow for highly accurate prediction of required transfer times.

### SUMMARY OF THE INVENTION

A first aspect of the present invention is directed to a required transfer time prediction device including: a plurality of automatic guided vehicles; a transfer instruction device that transmits, in response to transport requests issued from a plurality of requesters, transfer instructions to the plurality of automatic guided vehicles; a transfer information recorder that records a plurality of pieces of transfer information including transfer routes and required transfer times of the plurality of automatic guided vehicles that have been transferred in response to the transfer instructions; and a required transfer time predictor that predicts required transfer times for the respective automatic guided vehicles to be transferred along transfer routes based on the transfer instructions, wherein the required transfer time predictor predicts, upon receiving a current transport request issued from one of the requesters, the required transfer times using predicted required transfer time patterns generated through patterning based on the transfer information recorded by the transfer information recorder.

A second aspect of the present invention is directed to the required transfer time prediction device according to the first aspect of the present invention, wherein the required transfer time predictor selects, upon receiving a current transport request from one of the requestors, one of the plurality of automatic guided vehicles, determines a transfer route along which the selected one automatic guided vehicle is transferred from a current position thereof to a transfer destination, and predicts a required transfer time by applying the transfer route to the predicted required transfer time patterns.

A third aspect of the present invention is directed to the required transfer time prediction device according to the first aspect or the second aspect of the present invention, wherein the predicted required transfer time patterns include a plurality of recorded transfer routes and information of expected required transfer time values for the automatic guided vehicles, the expected required transfer time values being expected for each of the plurality of recorded transfer routes.

A fourth aspect of the present invention is directed to the required transfer time prediction device according to the third aspect of the present invention, wherein each of the recorded transfer routes includes one of a plurality of recorded locations as a recorded transfer route starting point and another one of the plurality of recorded locations as a recorded transfer route finishing point, and in a case where any of the transfer routes has a plurality of recorded locations thereon, the required transfer time predictor allocates, to the transfer route, one or more of the recorded transfer routes each having one of the plurality of recorded locations on the transfer route as the recorded transfer route starting point and another one of the plurality of recorded locations on the transfer route as the recorded transfer route finishing point, and calculates, as the required transfer time, a sum of expected required transfer time values for the automatic guided vehicles corresponding to the respective one or more recorded transfer routes allocated.

A fifth aspect of the present invention is directed to the required transfer time prediction device according to the third aspect or the fourth aspect of the present invention, wherein the required transfer time predictor calculates a delay time for each of the transfers of the automatic guided vehicles along the recorded transfer routes by referring to transfer rule information corresponding to the recorded transfer route.

A sixth aspect of the present invention is directed to the required transfer time prediction device according to the fifth aspect of the present invention, wherein the transfer rule information includes intersection waiting rule information for a case where two or more of the automatic guided vehicles simultaneously arrive at an intersection where at least portions of two or more of the recorded transfer routes overlap or intersect with each other, and the required transfer time predictor determines whether or not two or more of the automatic guided vehicles simultaneously arrive at an intersection by predicting the required transfer times for the respective two or more automatic guided vehicles, and calculates, upon determining that two or more of the automatic guided vehicles simultaneously arrive at an intersection, a waiting time of any of the two or more automatic guided vehicles at the intersection as the delay time based on the intersection waiting rule information.

A seventh aspect of the present invention is directed to the required transfer time prediction device according to any one of the first to sixth aspects of the present invention, further including: a transport request recorder that stores a plurality of pieces of transport request information including the transport requests issued from the plurality of requesters, and date and time of the issuance of each of the transport requests; and a transport request predictor that predicts, upon receiving a current transport request issued from one of the requesters, one or more future transport requests that are likely to be issued in the future from one or more other requesters, using predicted transport request time patterns or predicted transport request interval patterns generated through patterning based on the plurality of pieces of transport request information stored by the transport request recorder, wherein the required transfer time predictor further predicts required transfer times for the respective automatic guided vehicles to be transferred along transfer routes based on the one or more future transport requests.

An eighth aspect of the present invention is directed to the required transfer time prediction device according to the seventh aspect of the present invention, further including an allocation determiner that determines allocation of one of the plurality of automatic guided vehicles to each of the current transport request and the one or more future transport requests, by taking into account the current transport request and the one or more future transport requests, wherein the allocation determiner includes: an allocator that generates a plurality of allocation models by allocating, in different combinations or in different allocation patterns, candidate automatic guided vehicles among the plurality of automatic guided vehicles to transfer routes for each of the current transport request and the one or more future transport requests; an evaluation value calculator that calculates an evaluation value for each of the plurality of allocation models generated by the allocator; and a selector that selects one of the allocation models based on the plurality of evaluation values calculated by the evaluation value calculator.

A ninth aspect of the present invention is directed to the required transfer time prediction device according to the eighth aspect of the present invention, wherein the allocation determiner further includes: a modifier that modifies the required transfer times predicted by the required transfer time predictor for each of the plurality of allocation models generated by the allocator, by taking into account times of the issuance of the transport requests and a delay time; and an arrival time predictor that predicts arrival times of the respective automatic guided vehicles for each of the plurality of allocation models generated by the allocator, using the required transfer times modified by the modifier.

A tenth aspect of the present invention is directed to the automatic vehicle dispatching system according to any one of the eighth to ninth aspects of the present invention, wherein the evaluation value is a sum of the required transfer times.

An eleventh aspect of the present invention is directed to the automatic vehicle dispatching system according to the ninth aspect of the present invention, wherein the evaluation value is a sum of the required transfer times modified by the modifier and the delay time.

A twelfth aspect of the present invention is directed to the automatic vehicle dispatching system according to any one of the seventh to eleventh aspects of the present invention, wherein the predicted transport request time patterns or the predicted transport request interval patterns are generated through patterning, by a long short-term memory method, of the plurality of pieces of transport request information stored by the transport request recorder.

A thirteenth aspect of the present invention is directed to the automatic vehicle dispatching system according to the first to twelfth aspects of the present invention, wherein the predicted required transfer time patterns are generated through patterning, by a Gaussian process, of the plurality of pieces of transfer information recorded by the transfer information recorder.

A fourteenth aspect of the present invention is directed to a required transfer time prediction method including: transmitting, in response to transport requests issued from a plurality of requesters, transfer instructions to a plurality of automatic guided vehicles; recording, in a storage medium, a plurality of pieces of transfer information including transfer routes and required transfer times of the plurality of automatic guided vehicles that have been transferred in response to the transfer instructions; and predicting required transfer times for the respective automatic guided vehicles to be transferred along transfer routes based on the transfer instructions, wherein the predicting required transfer times including predicting, upon a current transport request being issued from one of the requesters, the required transfer times using predicted required transfer time patterns generated through patterning based on the recorded transfer information.

According to the present invention, it is possible to predict required transfer times with high accuracy.

### BRIEF DESCRIPTION OF THE DRAWINGS

FIG. 1 is a diagram illustrating an example of a configuration of an automatic vehicle dispatching system according to an embodiment of the present invention.

FIG. 2 is a block diagram illustrating an example of an electrical configuration of an optimization server illustrated in FIG. 1.

FIG. 3 is a block diagram illustrating an example of an electrical configuration of a management server illustrated in FIG. 1.

FIG. 4 is a diagram illustrating an example of a right side of an external configuration of an automatic guided vehicle (AGV) illustrated in FIG. 1.

FIG. 5 is a diagram illustrating an example of a bottom side of the external configuration of the AGV illustrated in FIG. 1.

FIG. 6 is a block diagram illustrating an example of an electrical configuration of the AGV illustrated in FIG. 1.

FIG. 7 is a diagram showing an overview of an example of an environment in which AGVs are used.

FIG. 8 is a diagram for explaining content of transport request record data.

FIG. 9 is a diagram for explaining predicted transport request interval patterns.

FIG. 10 is a diagram for explaining content of standardized information.

FIG. 11 is a diagram for explaining predicted required transfer time patterns.

FIG. 12 is a schematic diagram illustrating transfer routes for AGVs in a simplified manner.

FIG. 13 is a diagram for explaining an example of a method for predicting arrival times of AGVs.

FIG. 14 is a diagram for explaining another example of the method for predicting arrival times of AGVs.

FIG. 15 is a diagram illustrating an example of a memory map of RAM in the optimization server illustrated in FIG. 2.

FIG. 16 is a diagram illustrating an example of a memory map of RAM in the management server illustrated in FIG. 3.

FIG. 17 is a flow chart showing an example of a transfer instruction process to be performed by a CPU in the optimization server illustrated in FIG. 2.

FIG. 18 is a flowchart showing a portion of an example of an AGV control process to be performed by a CPU in the management server illustrated in FIG. 3.

FIG. 19 is a flowchart subsequent to that in FIG. 18, showing another portion of the AGV control process to be performed by the CPU in the management server illustrated in FIG. 3.

### DESCRIPTION OF THE PREFERRED EMBODIMENTS

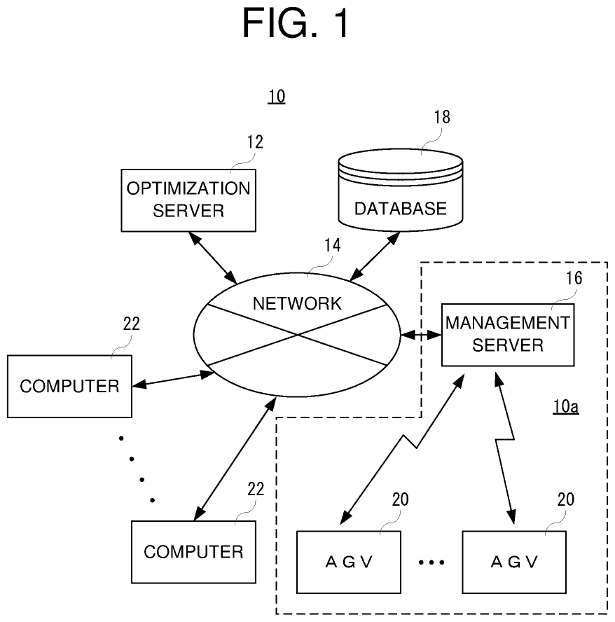

FIG. 1 is a diagram illustrating an example of a configuration of an automatic vehicle dispatching system (referred to below as a “system”) 10 according to an embodiment of the present invention. The system 10 is applied to a developer or a receiver of automatic guided vehicles described below, which are referred to also as autonomous guided vehicles or unmanned transport vehicles (referred to below as AGVs). The system 10 optimizes a plan for item transport by the AGVs, and manages and controls travel of the AGVs.

The receiver of the AGVs is a factory, and each AGV travels (or moves) from one base position to another in the factory. The term “base position” as used herein means a standby point of the AGV, an item (in-process item in the present embodiment) loading point, and a transport destination of an item (including a storage point). In the present embodiment, each AGV moves from a standby point to an item loading point, transports an item from the item loading point to a transport destination, and returns from the transport destination to the standby point. In the present embodiment, furthermore, the term “base position” encompasses a charging station. Each AGV is transferred to a charging station when remaining battery power of the AGV falls below a predetermined value.

In a factory, for example, a plurality of manufacturing operation devices are disposed, and the manufacturing operation devices perform operations in respective upstream to downstream processes such as an assembly process, an inspection process, and a packaging process. Each of the manufacturing operation devices transmits, upon completion of a current operation on an in-process item, a request (referred to below as a “transport request”) to a management server 16 to transport (or carry away) the in-process item done with the current operation to a downstream process, and transmits a transport request to the management server 16 to transport (or carry in) the next in-process item from an upstream process. In other words, locations or positions of the plurality of manufacturing operation devices are equivalent to the base positions as defined above.

Returning to FIG. 1, the system 10 includes an optimization server 12. The optimization server 12 is connected to the management server 16 via a network 14 such as the Internet, a wide area network (WAN), or a local area network (LAN), and is thus enabled for communication (transmission and/or reception) with the management server 16. The system 10 also has a database 18 on the network 14. The optimization server 12 and the management server 16 are each connected to the database 18, and are thus enabled for communication with the database 18.

The management server 16 is also wirelessly connected to each of a plurality of AGVs 20, and is thus enabled for communication with each AGV 20. However, in a place (factory in the present embodiment) where the AGVs 20 travel autonomously or automatically, a plurality of access points are provided, and each of the AGVs 20 communicates with the management server 16 via an additional network (different network from the network 14 described above) that includes the access points. In the present embodiment, data that is communicated between the management server 16 and each AGV 20 includes identification information of the AGV 20, so that the data can be transmitted to a specified AGV 20, and an AGV 20 can be specified (identified) based on received data.

Furthermore, the management server 16 is connected to a plurality of computers 22 via the network 14, and is thus enabled for communication with each computer 22. The plurality of computers 22 are disposed in respective base positions in the factory where the plurality of AGVs 20 reside. Alternatively, the computers 22 may be incorporated into the manufacturing operation devices disposed in the respective base positions. Alternatively, a terminal owned by a manager of the manufacturing operation devices disposed in the respective base positions may be used as the computers 22.

It should be noted that although the management server 16 in the present embodiment is described as being communicatively connected to the plurality of computers 22 via the network 14, the present invention is not limited as such. Since the factory has the additional network as described above, the management server 16 may be communicatively connected to some or all of the computers 22 via the additional network.

The management server 16 and the plurality of AGVs 20 form a transport system 10a.

The optimization server 12 optimizes a transport plan for the plurality of AGVs 20. Specifically, the optimization server 12 in the present embodiment is a device that functions as: a prediction device that predicts a time at which the next transport request is likely to be issued by a computer 22; a transport plan generation device that generates a plurality of models (referred to below as “allocation models”) for combinations of AGVs 20 allocated to each of a plurality of transport requests; a prediction device that predicts, for each of the plurality of allocation models, required transfer times (each including a time until a transport request is issued and a delay time due to, for example, congestion) or arrival times for respective AGVs 20; a transport plan evaluation device that evaluates each of the plurality of allocation models and selects one optimal allocation model; and a transfer instruction generation device that generates a transfer instruction based on the selected allocation model and transmits the generated transfer instruction to the management server 16.

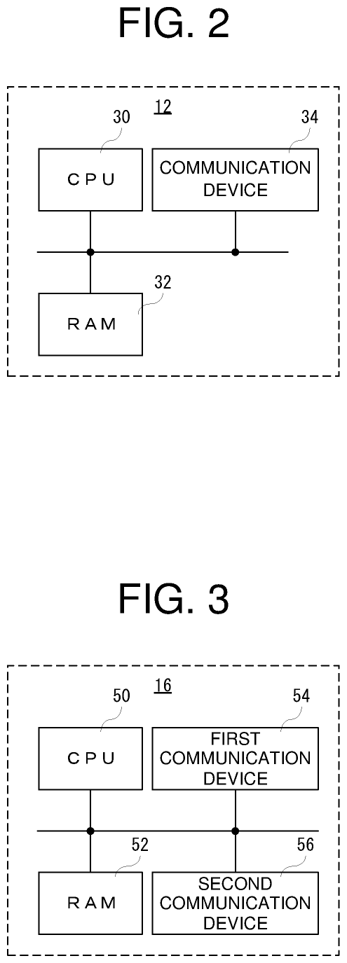

A general-purpose server can be used as the optimization server 12. FIG. 2 is a block diagram illustrating an example of an electrical configuration of the optimization server 12. As illustrated in FIG. 2, the optimization server 12 includes a central processing unit (CPU) 30, and the CPU 30 is connected to random access memory (RAM) 32 and a communication device 34 via an internal bus. Although not shown, the optimization server 12 includes other components such as a hard disk drive (HDD) and read-only memory (ROM) as auxiliary storage devices.

The CPU 30 is a processor that performs overall control of the optimization server 12. The RAM 32 is a main storage device of the optimization server 12 and serves as a buffer area and a work area for the CPU 30. The communication device 34 is a communication module for wired or wireless communication in accordance with a communication method such as Ethernet or Wi-Fi.

It should be noted that description of the same circuit components as in the optimization server 12 will be omitted when block diagrams of the management server 16 and the AGVs 20 are described below.

The management server 16 is a device that manages the transfer of the AGVs 20. More specifically, the management server 16 is a device that functions as: a transfer instruction device that instructs or controls the transfer of the AGVs 20; and an acquisition device that acquires, from each AGV 20, travel information including a measurement value reflecting the state of the AGV 20. A general-purpose server can be used as the management server 16. As illustrated in FIG. 3, the management server 16 includes a CPU 50, and the CPU 50 is connected to RAM 52, a first communication device 54, and a second communication device 56 via an internal bus.

The first communication device 54 in the management server 16 is a communication module for communication with the network 14, and has the same functions as the communication device 34 described above. The second communication device 56 is a communication module for wireless communication with other devices (AGVs 20 in the present embodiment). The second communication device 56 is a wireless communication module enabled for LAN connection and adopts, for example, Wi-Fi or ZigBee (registered trademark) as a communication method.

The database 18 is a general-purpose database, and is accessible by the optimization server 12 and the management server 16 in the present embodiment. The database 18 stores information on past transport requests (referred to below also as a “transport request record”), information on past transfer instructions (referred to below also as a “transfer instruction record”), a history of the travel information of the AGVs 20 (referred to below also as a “travel record”), and master information.

The transport request record is record information (log data) in which transport request information received by the management server 16 from the computers 22 is recorded in chronological order. The transfer instruction record is record information in which transfer instructions transmitted from the management server 16 to the AGVs 20 are recorded in chronological order. The travel record is record information in which the travel information of the AGVs 20 acquired by the management server 16 is recorded in chronological order.

The travel information of each AGV 20 includes date and time information, AGV_ID, transport request ID, transport destination location information, transport destination ID, AGV 20 current position, AGV 20 state, and intersection information. However, these are merely non-limiting examples. In the present embodiment, the travel information of each AGV 20 is stored at a first predetermined time interval (every 2 seconds in the present embodiment) and kept for a first predetermined time while the AGV 20 is traveling.

The AGV_ID is identification information for individually identifying each AGV 20, and is expressed using a symbol and a number in the present embodiment. The transport request ID is identification information for individually identifying each transport request, and is expressed using a single letter and a four-digit number in the present embodiment.

The transport destination location information is unique location information assigned to each transport destination, and is expressed using a number in the present embodiment. The transport destination ID is identification information for individually identifying each transport destination, and is expressed using a two-digit number in the present embodiment.

The AGV 20 current position is positional coordinates of the current position of the AGV 20 on a map. The AGV 20 state includes information such as the usage state (on standby or in transfer), speed, voltage (voltage value of a battery 94), load information (cargo load), and errors (sudden acceleration, sudden deceleration, deviation from a transfer route).

The intersection information of each AGV 20 is added to the travel information when the AGV 20 is at an intersection (being on standby while being stopped at the intersection or entering the intersection), and includes location information of the intersection and a state, which specifically is a standby state or an entering state. The intersection information is not added to the travel information unless the AGV 20 is at an intersection (NULL information).

The master information is necessary for the travel of the plurality of AGVs 20 in the transport system 10a. The master information in the present embodiment includes basic information, travel parameter information, map information, location information of each base position, transfer route information, intersection location information, and travel rule information.

The basic information is identification information of each AGV 20 and each base position. The travel parameter information represents travel parameters including values of a plurality of parameters such as P value, I value, and D value for performing steering control of each traveling AGV 20 through PID control. The travel parameter information is prepared for each transfer route.

It should be noted that the PID control is a control method involving determining a difference between an output and a target value (deviation), combining three terms of the deviation including proportional (P), integral (I), and differential (D) terms in an appropriate ratio, and thus providing feedback. In the present embodiment, the ratio between a feedback quantity of the proportional term, a feedback quantity of the integral term, and a feedback quantity of the differential term of the deviation is selected as appropriate so that the AGV 20 travels along a line.

Although the PID control is adopted as a feedback control method in the present embodiment, PI control, P control, on-off control, or PD control may alternatively be adopted in other embodiments.

The map information represents a map of the factory where the plurality of AGVs 20 reside, and mainly indicates the base positions and courses along which the AGVs 20 can travel. Location information of each base position represents positional coordinates of the base position on the map.

The transfer route information represents a transfer route predetermined or set between the two base positions. In the present embodiment, the transfer route information includes identification information of one base position being a transfer starting point, identification information of the other base position being a transfer finishing position, and identification information of a location (relay point) for the AGV 20 to pass through (including to change direction at) or stop at between the two base positions. However, the transfer route information only includes identification information of relay points predetermined by an authorized person such as an administrator of the system 10 among all relay points.

The intersection location information represents positional coordinates of an intersection (including T-shaped intersection) where two or more routes intersect with one another among the courses along which each AGV 20 can travel on the map. The travel rule information includes: predetermined actions at predetermined locations on the map; rules for each of an obstacle detection action, a passing action, and an intersection action; and identification information of travel parameters for each of the actions.

In the present embodiment, the predetermined actions mean straight-ahead travel, backward travel, stop, moving over to the left, moving over to the right, turn (left turn, right turn), and speed change (acceleration, deceleration) actions.

Rules for the obstacle detection action include stopping the AGV 20 when an obstacle that interferes with the transfer thereof is detected in front of or in a moving direction of the AGV 20 and notifying the management server 16 that an obstacle has been detected.

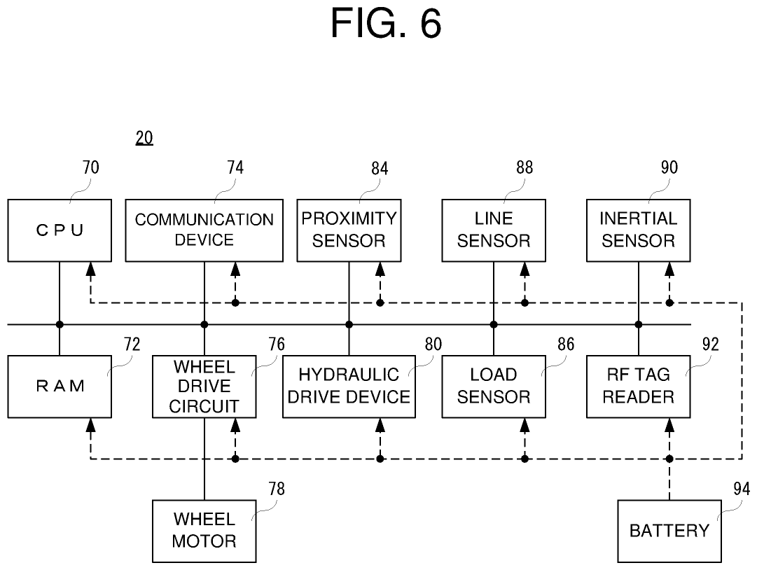

It should be noted that, although not shown in FIG. 6 described below, each AGV 20 includes a sensor (for example, a laser rangefinder or a sound sensor) at a front end (and a rear end) thereof for detecting obstacles.

Rules for the passing action include causing one of two AGVs 20 traveling toward each other on the same route to move over to the left or to the right. The AGV 20 moves over to the left in the case of left-side traveling and moves over to the right in the case of right-side traveling. Left-side traveling or right-side traveling is set for each environment in which the AGVs 20 are used.

Rules for the intersection action include permitting an AGV 20 that is traveling one of two routes having an intersection and another AGV 20 that has come in the other route while the former is traveling to enter the intersection on a first-come basis. In a case where two AGVs 20 come in their respective routes having an intersection at the same time, the AGVs 20 are permitted to enter the intersection in accordance with a priority. In the present embodiment, an AGV 20 assigned a smaller (or larger) AGV_ID number is given a higher priority. However, this is merely one example, and an AGV 20 having lower (or higher) remaining battery power may be given a higher priority in another embodiment.

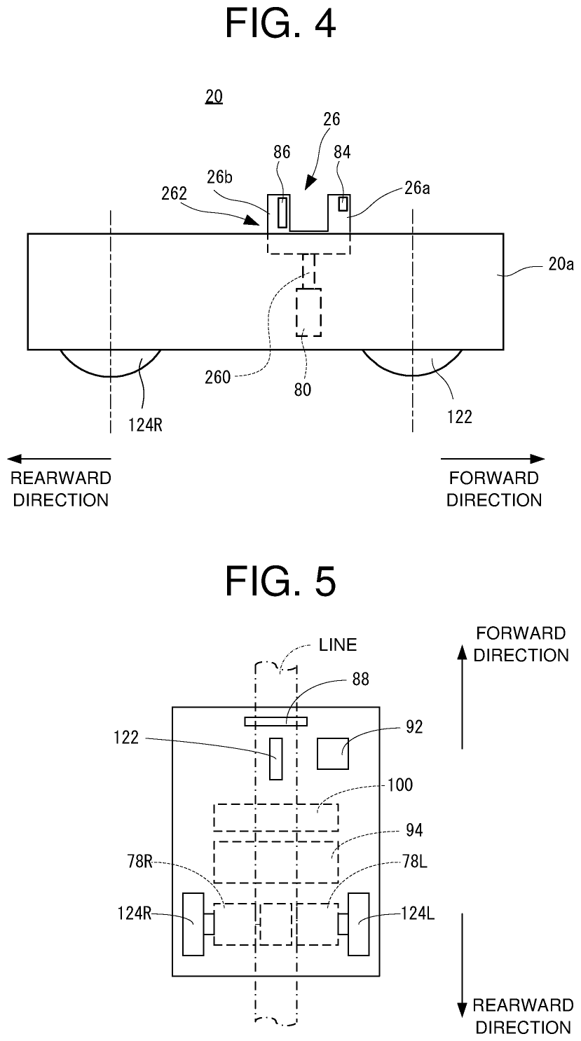

The AGVs 20 are autonomous robots and each tow a cart, which is a tow object, as necessary in the present embodiment. FIG. 4 is a diagram illustrating a right side of an external configuration of an AGV 20. FIG. 5 is a diagram illustrating a bottom side of the external configuration of the AGV 20. In FIG. 4, a rightward direction is a frontward direction in the AGV 20, and a leftward direction is a rearward direction in the AGV 20. In FIG. 5, an upward direction is the frontward direction in the AGV 20, and a downward direction is the rearward direction in the AGV 20.

Although not shown, the cart is a roll box cart, which is referred to also as a roll box pallet or a cage cart. The cart includes a loading base and casters, which are free wheels, respectively provided at four corners of a lower side of the loading base. A cage is provided on the top of the loading base.

The AGV 20 includes a vehicle body 20a and a pair of left and right liftable towing arms 26 provided at an upper portion of the vehicle body 20a for towing the cart. The vehicle body 20a has a low rectangular parallelepiped shape and is insertable into a space between a lower surface of the cart and the floor or ground. The towing arms 26, for which detailed description is omitted, include a hydraulic cylinder 260 and a coupler 262 that couples the cart to the towing arms 26. The hydraulic cylinder 260 is lifted and lowered by a hydraulic drive device 80, lifting and lowering the coupler 262. An end face of the coupler 262 has a recessed shape in a side view of the towing arms 26.

The lifting or lowering length of the towing arms 26 is predetermined because the cart to be used is predetermined. The rotation speed of a drive motor that drives a hydraulic pump incorporated in the hydraulic drive device 80 is also predetermined according to the lifting or lowering length. Although not shown, the hydraulic drive device 80 includes the hydraulic pump and the drive motor that drives the hydraulic pump.

FIG. 4 shows the towing arms 26 in a lifted state.

The coupler 262 of the towing arms 26 has a forward first part 26a and a rearward second part 26b. A proximity sensor 84 is provided on an upper portion of the first part 26a, and a load sensor 86 is provided on a frontward portion of a side of the second part 26b.

The proximity sensor 84 is, for example, a transmissive or reflective optical sensor that detects the lower surface of the cart when the cart is coupled to the AGV 20. Upon the AGV 20 being inserted under the cart (or the loading base) and the proximity sensor 84 detecting a rear edge of the lower surface of the cart, the AGV 20 stops after moving forward from this position to a coupling position located further forward by a predetermined distance.

A coupler to be coupled to (or engaged with) the towing arms 26 is provided on the lower side of the loading base. The coupler has a square cylinder shape (funnel shape) in which the cylinder extends in an up-down direction on the lower side of the loading base.

A plate member forming the coupler is placed between the first part 26a and the second part 26b of the towing arms 26 (coupler 262) when the towing arms 26 are lifted after the AGV 20 has stopped. The plate member is then engaged with the second part 26b when the AGV 20 moves, allowing the AGV 20 to tow the cart.

The load sensor 86 is a general-purpose load sensor that detects load applied to the AGV 20 (or the towing arms 26) when the AGV 20 is towing the cart. This load means cargo load including load of the cart. Load of the cart and the item loaded on the cart herein will be referred to simply as “cargo load”.

As illustrated in FIG. 5, the AGV 20 has three wheels on a lower surface of the vehicle body 20a. In the present embodiment, the wheels include one front wheel 122, and left and right rear wheels 124L and 124R. The front wheel 122 is an auxiliary wheel and is pivotable relative to the vehicle body 20a. The left and right rear wheels 124L and 124R are drive wheels and are fixedly attached to the vehicle body 20a.

It is therefore possible to change the moving direction of the AGV 20 by causing the left and right rear wheels 124L and 124R to rotate at different rotation speeds. For example, stopping the rotation of the left rear wheel 124L (setting the rotation speed thereof to 0) and causing the right rear wheel 124R to rotate (setting the rotation speed thereof to greater than 0) makes the AGV 20 turn left. Stopping the rotation of the right rear wheel 124R (setting the rotation speed thereof to 0) and causing the left rear wheel 124L to rotate (setting the rotation speed thereof to greater than 0) makes the AGV 20 turn right.

The vehicle body 20a further includes therein a left wheel motor 78L and a right wheel motor 78R. The left wheel motor 78L is coupled to the left rear wheel 124L, and the right wheel motor 78R is coupled to the right rear wheel 124R. The wheel motors 78L and 78R are also connected to a wheel drive circuit 76.

The vehicle body 20a further includes the battery 94 and a control board 100. The control board 100 incorporates circuit components such as a CPU 70, RAM 72, a communication device 74, and an inertial sensor 90 described below.

The lower surface of the vehicle body 20a is provided with a line sensor 88 and a radio-frequency (RF) tag reader 92. In the present embodiment, the line sensor 88 is disposed in a position that is toward a front end of the AGV 20 and at a center in a left-right direction. In the present embodiment, the RF tag reader 92 is disposed in a position that is frontward of a center of the AGV 20 in a front-rear direction and leftward of the center in the left-right direction. These positions of the line sensor 88 and the RF tag reader 92 are merely non-limiting examples.

FIG. 6 is a block diagram illustrating an example of an electrical configuration of the AGVs 20 illustrated in FIG. 1. As illustrated in FIG. 6, each AGV 20 includes the CPU 70, and the CPU 70 is connected to the RAM 72, the communication device 74, the wheel drive circuit 76, the hydraulic drive device 80, the proximity sensor 84, the load sensor 86, the line sensor 88, the inertial sensor 90, and the RF tag reader 92 via a bus. The wheel drive circuit 76 is connected to the wheel motors 78. The battery 94 is connected to each component of the AGV 20.

The CPU 70 and the RAM 72 are as described above. Although not shown, the AGV 20 also includes memory other than the RAM 72 such as an HDD and ROM. The RAM 72 stores transfer route data and data of a map of an experimental environment or an operating environment in which the AGV 20 travels.

The communication device 74 is a communication module for wireless communication with another device (management server 16 in the present embodiment). For example, the communication device 74 is a communication module adopting the same communication method as the second communication device 56 of the management server 16 (for example, Wi-Fi or ZigBee (registered trademark)).

The wheel drive circuit 76 operates under the direction of the CPU 50 to generate a drive voltage for the wheel motors 78 and apply the generated drive voltage to the wheel motors 78. The wheel motors 78 operate to cause the rotation of the wheels of the AGV 20. As described above, although not shown in FIG. 6, the wheel motors 78 include the left wheel motor 78L that drives the left rear wheel 124L and the right wheel motor 78R that drives the right rear wheel 124R among the two rear wheels (124L, 124R) of the AGV 20. The wheel motor 78L and the wheel motor 78R are separately driven by the wheel drive circuit 76, so that the AGV 20 travels straight ahead, turns left, turns right, accelerates, decelerates, and stops. Although not shown, each of the wheel motor 78L and the wheel motor 78R is provided with an encoder, and the rotation speed of the wheel motor is detected by the encoder and notified to the CPU 50. Although not shown, the left rear wheel 124L is directly connected to a rotation shaft of the wheel motor 78L, and the right rear wheel 124R is directly connected to a rotation shaft of the wheel motor 78R. The CPU 50 can therefore know the rotation speed of the rear wheel 124L and the rotation speed of the rear wheel 124R through detection of the rotation speed of the wheel motor 78L and the rotation speed of the wheel motor 78R.

The hydraulic drive device 80 includes a drive circuit for generating a drive voltage for the drive motor and applying the generated drive voltage to the drive motor under the direction of the CPU 50. The drive motor drives the hydraulic pump to lift and lower the hydraulic cylinder 260 of the towing arms 26.

As described above, the proximity sensor 84 is a transmissive or reflective optical sensor in the present embodiment. As described above, the load sensor 86 is a general-purpose load sensor in the present embodiment.

The line sensor 88 is a magnetic sensor including a plurality of (for example, eight) detection elements arranged side by side and detects a line along which the AGV 20 moves (referred to also as a guiding line or a guide) installed in (or attached to) the factory floor. In the present embodiment, each of the plurality of detection elements is a Hall element, and a distance between adjacent detection elements is set to a predetermined length. The line is formed of magnetic tape and has a predetermined width. The line is provided on a course along which the AGV 20 moves (or travels). Thus, the AGV 20 is transferred along the line as described below.

The inertial sensor 90 is an acceleration sensor and detects an acceleration rate of the AGV 20. In the present embodiment, the inertial sensor 90 is used to detect the number of sudden accelerations and sudden decelerations of the AGV 20. As the acceleration sensor, therefore, a single-axis acceleration sensor capable of detecting the acceleration rate in the front-rear direction of the AGV 20 is usable. The travel speed of the AGV 20 can be determined by integrating an average value of the acceleration rate detected by the acceleration sensor over the first predetermined time (2 seconds in the present embodiment). The management server 16 may calculate the travel speed of the AGV 20.

The RF tag reader 92 reads tag information of RFID tags installed in (or attached to) the factory floor. In the present embodiment, each of the RFID tags is installed in a position that is located in the vicinity of the line and in which the AGV 20 is desired to perform a predetermined action different from normal transfer. The position in which the AGV 20 is desired to perform a predetermined action is, for example, a base position, a position for the AGV 20 to turn (left turn, right turn), and a position for the AGV 20 to change the travel speed (acceleration, deceleration). The base position is for the AGV 20 to stop.

The AGV 20 therefore reads the tag information of each RFID tag using the RF tag reader 92 and communicates with the management server 16 based on the read tag information. The management server 16 grasps the position (i.e., current position) of each AGV 20, transmits a transfer instruction to each AGV 20, and transmits an instruction for a predetermined action (any of stop, left turn, right turn, and speed change (i.e., acceleration and deceleration) actions) to each AGV 20 at each predetermined position.

Furthermore, each AGV 20 knows its own transfer route and is able to know the rotation speed of each wheel motor 78 thereof. At a location where the tag information cannot be read, therefore, each AGV 20 can know its current position by calculating, based on the rotation speed of each wheel motor 78, a distance the AGV 20 has moved since the tag information was last read and referring to map data.

The battery 94 is a rechargeable secondary battery. Examples of usable batteries include a lithium-ion battery. The battery 94 supplies power to each circuit component of the AGV 20. In FIG. 6, electric wires are represented by dashed lines to distinguish the electric wires from signal lines. Although not shown, the CPU 70 can detect the voltage value of the battery 94 and know the remaining battery power based on the voltage value.

In the system 10 having the above-described configuration, the management server 16 specifies transfer routes and controls the travel of the AGVs 20 using prepared travel parameters. Each of the AGVs 20 moves without load or with towing a cart in the factory where the AGVs 20 reside.

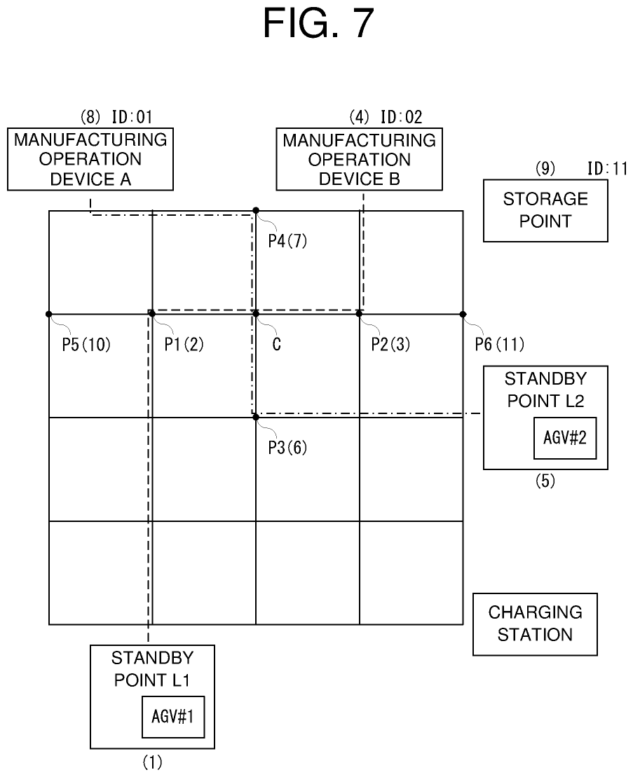

FIG. 7 shows an example of a map of a place (e.g., factory) where the AGVs 20 reside and travel. In FIG. 7, a standby point L1 and a standby point L2 are locations or areas where one or more AGVs 20 that are not transporting any items stay on standby.

At a storage point, in-process items or completed items are temporarily stored for delivery (or shipment) to another place.

A manufacturing operation device A and a manufacturing operation device B respectively perform operations on in-process items. These operations each mean the operation in any of the upstream to downstream processes such as the assembly process, the inspection process, and the packaging process.

A charging station is a location or an area for charging the batteries 94 of the AGVs 20.

Solid lines arranged in a matrix represent guiding lines installed in the factory where the AGVs 20 reside and travel. As described above, each AGV 20 travels along a guiding line. That is, the solid lines arranged in a matrix represent, in other words, courses along which the AGVs 20 travel.

The number and the locations of standby points, manufacturing operation devices, storage points, and charging stations are merely non-limiting examples, and may be changed as appropriate depending on the place where the AGVs 20 reside. In the present embodiment, for the sake of clarity, fewer standby points, manufacturing operation devices, storage points, and charging stations are shown.

Furthermore, parenthesized numbers in FIG. 7 indicate location information assigned to the respective base positions and predetermined positions. The predetermined positions are relay points for traveling AGVs 20. In an example illustrated in FIG. 7, a transfer route for an AGV 20 on standby at the standby point L1 to move to the location of the manufacturing operation device B is represented by dashed lines. In this example, this AGV 20 goes through a relay point P1 and a relay point P2. A transfer route for an AGV 20 on standby at the standby point L2 to move to the location of the manufacturing operation device A is represented by dashed and dotted lines. In this example, this AGV 20 goes through a relay point P3 and a relay point P4.

In FIG. 7, for drawing legibility, the lines representing the transfer routes are slightly off the guiding lines.

Furthermore, as will be described later, a relay point P5 is provided on a transfer route to be followed when the AGV 20 on standby at the standby point L1 moves along a leftmost longitudinal guiding line in FIG. 7 to the location of the manufacturing operation device A. A relay point P6 is provided on a transfer route to be followed when the AGV 20 on standby at the standby point L2 moves along a rightmost longitudinal guiding line in FIG. 7 to the location of the manufacturing operation device B.

Furthermore, a two-digit number (“01” and “02” in this example) is assigned to each of the manufacturing operation device A and the manufacturing operation device B as identification information of a transport requester (i.e., transport requester ID). Likewise, a two-digit number (“11” in this example) is assigned to the storage point as a transport destination ID. Furthermore, a symbol and a number (“#1” and “#2” in this example) is assigned to each AGV 20 as AGV_ID.

In a conventional transport system 10a, the management server 16 controls an available AGV 20 to transport an item upon a request to transport the item from a manufacturing operation device (referred to below as a “transport request”). A person who manages the manufacturing operation device specifies a transport destination and issues a transport request. Alternatively, the manufacturing operation device may automatically issue a transport request. Alternatively, an administrator of the management server 16 may input a transport request to the management server 16.

Upon a transport request, the management server 16 in the conventional transport system 10a acquires, from the database 18, a transfer route from the transport starting point to the transport destination for the AGV 20 among transfer routes preset for respective base positions, and also acquires, from the database 18, preset travel parameters corresponding to the transfer route.

The management server 16 also selects an available AGV 20 and assigns the selected AGV 20 to accommodate the transport request. The available AGV 20 means an AGV 20 that is on standby and that has no transport request assigned thereto, and encompasses not only the AGVs 20 on standby at the standby points L1 and L2 but also AGVs 20 on standby in other base positions. The management server 16 selects an AGV 20 on standby in the position closest to the manufacturing operation device that has issued the transport request.

The management server 16 then transmits, to the selected AGV 20, a transfer instruction including the transfer route and the travel parameters that have been acquired. The AGV 20 then moves in accordance with the transfer route included in the transfer instruction using the travel parameters included in the transfer instruction.

In a case where a plurality of transport requests are issued, the management server 16 sequentially acquires, for each of the transport requests, a transfer route and travel parameters from the database 18, and selects an AGV 20 on standby in the position closest to the manufacturing operation device that has issued the transport request.

As described above, the conventional transport system 10a selects an optimal AGV 20 for the current transport request without taking into account any future transport requests. In terms of an overall transport operation including a transport request that is likely to be issued in the relatively near future as well as the current transport request, therefore, the conventional transport system 10a can make waste of transport time and power consumed by AGVs 20.

One factor of such waste is, for example, that selecting and transferring, in response to the current transport request, an AGV 20 on standby at the standby point closest to the transport request location relocates this AGV 20, and in a case where a new transport request is issued at the transport request location close to the standby point immediately after the relocation, it is necessary to transfer another AGV 20 from a farther standby point. These standby points include not only the standby points L1 and L2 but also other base positions having stopped AGVs 20 without being used for transport.

Furthermore, in a case where a plurality of transport requests are issued, the conventional transport system 10a is to select an optimal AGV 20 for each of the transport requests. This is another factor that causes the waste of transport time and power consumed by AGVs 20 in terms of an overall transport operation.

In a case where a plurality of transport requests are issued at the same time or in succession, for example, a large number of combinations are possible in terms of which AGV 20 to select for each transport request. Selecting an AGV 20 for one of the transport requests in this case can result in selecting a suboptimal AGV 20 for another transport request.

Furthermore, in a case where an item is transported from a first base position to a second base position by an AGV 20 selected from among a plurality of AGVs 20, the conventional transport system 10a selects an AGV 20 expected to arrive at the first base position at a second predetermined time determined based on a transport time, which is a period of time required for the transport from the first base position to the second base position, and the thus selected AGV 20 transports the item.

However, the second predetermined time can be wrong due to the actual transport time taken for the transport from the first base position to the second base position being different from what is expected. That is, the prediction of the arrival time of the AGV 20 is less accurate in a system 10 including the conventional transport system 10a.

The present embodiment therefore has a configuration that increases the accuracy of the arrival time prediction as well as reduces the waste of transport time and power consumed by AGVs 20 in terms of an overall transport operation.

In brief, the system 10 according to the present embodiment individually stores (or accumulates) a plurality of transport requests and the travel information of AGVs 20 that have been transferred in response to the respective transport requests, and generates predicted transport request interval patterns and predicted required transfer time patterns based on the stored transport requests and travel information. The system 10 according to the present embodiment then predicts arrival times of the AGVs 20 using these predicted patterns and selects (i.e., dispatches) an AGV 20 to accommodate a transport request.

The following describes in detail a case where a plurality of AGVs 20 are transferred in an operating environment corresponding to the map shown in FIG. 7.

Generation of Predicted Transport Request Interval Patterns Before the predicted transport request interval patterns and the predicted required transfer time patterns are generated, as described above, the management server 16 acquires, upon receiving each of transport requests issued from the manufacturing operation device A and the manufacturing operation device B, a transfer route and travel parameters for the transport request from the database 18. The management server 16 then selects an AGV 20 on standby in the position closest to the transport requester from among one or more available AGVs 20 and transmits a transfer instruction including the transfer route and the travel parameters to the selected AGV 20. The management server 16 also records information on the transport requests (transport request information) in the database 18.

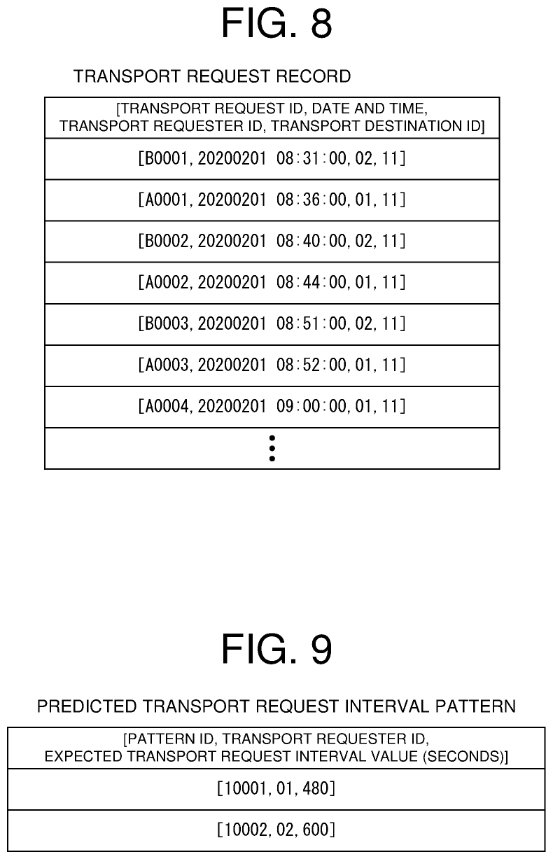

FIG. 8 shows an example of a transport request record. In the transport request record shown in FIG. 8, transport request information is recorded in chronological order. The transport request information includes various information such as transport request ID, date and time information, transport requester ID, and transport destination ID. The transport request ID is identification information of each transport request, and is expressed using a single letter and a four-digit number. In the present embodiment, the single letter indicates a transport requester, that is, the manufacturing operation device A or the manufacturing operation device B, and the four-digit number indicates an issuance order of the transport request. As such, the transport request ID “B0001” indicates that the transport request is the first transport request issued by the manufacturing operation device B. The same applies to other cases.

The date and time information is expressed using an 8-digit number indicating year (A.D.), month, and day, and numbers and symbols (colons) indicating time (hour, minute, second). The date and the time have a space therebetween. As such, the date and time information “20200201 08:36:00” indicates 8:36 and 00 seconds on Feb. 1, 2020. The same applies to other cases.

The transport requester ID is identification information of each transport request issuer, and is preassigned to each of the manufacturing operation device A and the manufacturing operation device B. In the present embodiment, the transport requester ID is expressed using a two-digit number. The manufacturing operation device A is assigned transport requester ID “01”, and the manufacturing operation device B is assigned transport requester ID “02”. In the present embodiment, the number on the left side of the two-digit number indicates that the ID is for a transport requester.

The transport destination ID is identification information of each transport destination, and is preassigned to each transport destination (storage point in FIG. 7). In the present embodiment, the transport destination ID is expressed using a two-digit number. The transport destination ID “11” is assigned to the storage point. In the present embodiment, the number on the left side of the two-digit number indicates that the ID is for a transport destination.

Although FIG. 7 shows only one storage point, a plurality of storage points may be provided. In this case, each of the storage points is assigned a unique transport destination ID.

Furthermore, as described above, an in-process item may be transported from the location of a manufacturing operation device to the location of another manufacturing operation device. Accordingly, one manufacturing operation device may be assigned both the transport requester ID and the transport destination ID.

Based on the above-described transport request record, which in other words is past transport request information, the predicted transport request interval patterns are generated through patterning by a known long short-term memory (LSTM) method.

FIG. 9 is a diagram illustrating examples of the predicted transport request interval patterns generated based on the transport request record shown in FIG. 8. The predicted transport request interval patterns each include pattern ID, transport requester ID, and an expected transport request interval value (seconds). The pattern ID is expressed using a five-digit number. The leftmost number indicates that the ID is for a predicted transport request interval pattern. The remaining four-digit number represents a serial number assigned to the predicted pattern. As described above, the transport requester ID is identification information assigned to each manufacturing operation device being a transport request issuer. The expected transport request interval value (seconds) is an expected value (seconds) of the time interval between transport requests to be issued by the manufacturing operation device indicated by the transport requester ID.

For example, the predicted transport request interval pattern [10001, 01, 480] indicates that the pattern ID is “10001”, the transport requester is the manufacturing operation device A, and the expected value of the time interval between transport requests to be issued by the manufacturing operation device A is 480 seconds. The same applies to the other predicted transport request interval patterns.

In the present embodiment, one predicted transport request interval pattern is generated for each transport requester (manufacturing operation device). Accordingly, three or more predicted transport request interval patterns are generated for three or more transport requesters.

Generation of Predicted Required Transfer Time Patterns Before the predicted required transfer time patterns are generated, the management server 16 records the travel information acquired from each AGV 20 in the database 18.

In the present embodiment, as described above, the travel information is transmitted from each AGV 20 to the management server 16 at the first predetermined time interval. Consequently, a huge amount of travel information is stored. In the present embodiment, therefore, information in a format suitable for patterning (learning) (referred to below as “standardized information”) is created for each transport request by integrating a plurality of pieces of travel information as a unit section from a transfer starting point to a transfer finishing point of the AGV 20 engaged in the transport request.

Specifically, in a case where an AGV 20 having AGV_ID #1 starts moving from the standby point L1 (location information (1)) on Feb. 1, 2020, and arrives (i.e., finishes moving) at the location of the manufacturing operation device B (location information (4)) 146 seconds later, 73 pieces of travel information are stored during the 146 seconds. These 73 pieces of travel information are integrated to create a piece of standardized information.

The arrival time at each base position can be obtained from the date and time information included in the travel information and the current position of the AGV 20.

Based on the 73 pieces of travel information, a required transfer time to each relay point (each of the point having location information (2) and the point having location information (3) in the example shown in FIG. 7) located between the point having location information (1) (i.e., transfer starting point) and the point having location information (4) (i.e., transfer finishing point) is determined (or calculated). For example, the required transfer time for a transfer from the point having location information (1) to the point having location information (2) is 88 seconds, and the required transfer time for a transfer from the point having location information (1) to the point having location information (3) is 116 seconds.

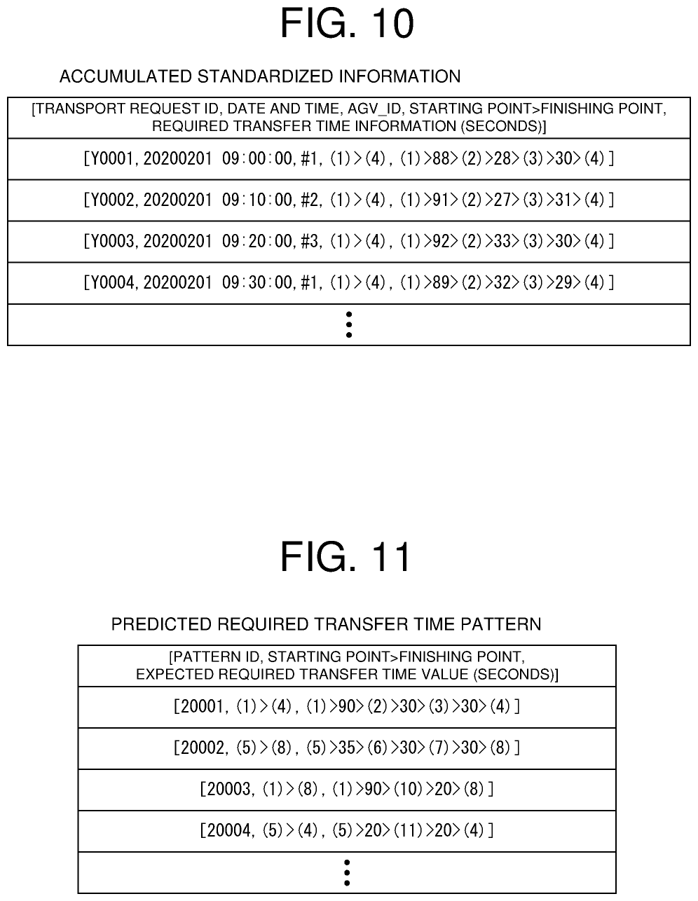

FIG. 10 illustrates examples of a plurality of pieces of standardized information accumulated. The standardized information includes various information such as standardized information ID, date and time information, AGV_ID, starting point>finishing point (transfer route), and required transfer time information (seconds).

The standardized information ID is identification information of each piece of standardized information, and is expressed using a single letter and a four-digit number. The single letter indicates that the information is standardized information, and the four-digit number represents a serial number assigned to the standardized information.

The date and time information is, as described above, date (year (A.D.), month, day) and time (hour, minute, second). In the present embodiment, the date and time information indicates a date and time at which the AGV 20 started moving. The AGV_ID is, as described above, identification information assigned to the AGV 20.

The starting point>finishing point is section information indicating a transfer starting point and a transfer finishing point, which in other words is information indicating a transfer route. In this example, a left-opening inequality sign is used between the location information of the starting point and the location information of the finishing point. The inequality sign resembles the shape of an arrowhead, and thus indicates a direction in which the AGV 20 is headed. Hereinafter, the same applies to all cases where an inequality sign is used. However, an unparenthesized number between inequality signs indicates a time required for a transfer between points indicated by parenthesized numbers that have the inequality signs therebetween.

The required transfer time information indicates a required transfer time (seconds) for a transfer between every two adjacent points including one or more relay points among all points between a transfer starting point and a transfer finishing point.

An example of the standardized information is [Y000109:00:00, #1, (1)>(4), (1)>88>(2)>28>(3)>30>(4)]. This standardized information indicates: the standardized information ID is Y0001; an AGV 20 having identification information #1 started moving at 9:00 and 00 seconds on Feb. 1, 2020; the required transfer time for a transfer from the standby point L1 indicated by (1) to the relay point P1 indicated by (2) is 88 seconds; the required transfer time for a transfer from the relay point P1 to the relay point P2 indicated by (3) is 28 seconds; and the required transfer time for a transfer from the relay point P2 to the location of the manufacturing operation device B indicated by (4) is 30 seconds. The same applies to the other standardized information.

The examples shown in FIG. 10 are standardized information in a case where three AGVs 20 respectively having AGV_IDs #1, #2, and #3 were each transferred from the standby point L1 to the location of the manufacturing operation device B via the relay point P1 and the relay point P2. Although not shown, a large number of pieces of standardized information from other cases of transfers along other transfer routes are also accumulated.

The predicted required transfer time patterns are generated using the thus accumulated pieces of standardized information. FIG. 11 shows examples of the predicted required transfer time patterns generated based on the accumulated pieces of standardized information shown in FIG. 10. The predicted required transfer time patterns are generated on a per-transfer route basis.

The accumulated pieces of standardized information are subjected to patterning on a per-transfer route basis by, for example, a known Gaussian process. Each of the predicted required transfer time patterns shown in FIG. 11 includes pattern ID, starting point>finishing point (transfer route), and an expected required transfer time value (seconds).

The pattern ID is identification information of each predicted required transfer time pattern. The starting point>finishing point is, as described above, information indicating a transfer route. The expected required transfer time value (seconds) indicates an expected value (seconds) of a required transfer time between every two adjacent points including relay points among all points between a transfer starting point and a transfer finishing point.

An example of the predicted required transfer time patterns is [20001, (1)>(4), (1)>90>(2)>30>(3)>30>(4)]. This predicted required transfer time pattern indicates: the pattern ID is “20001”; the starting point is the standby point L1; the finishing point is the location of the manufacturing operation device B; the expected required transfer time value for a transfer from the standby point L1 to the relay point P1 is 90 seconds; the expected required transfer time value for a transfer from the relay point P1 to the relay point P2 is 30 seconds; and the expected required transfer time value for a transfer from the relay point P2 to the location of the manufacturing operation device B is 30 seconds. The same applies to the other predicted required transfer time patterns.

Arrival Time Prediction and Vehicle Dispatching

The following describes in detail arrival time prediction and vehicle dispatching using the predicted transport request interval patterns and the predicted required transfer time patterns.

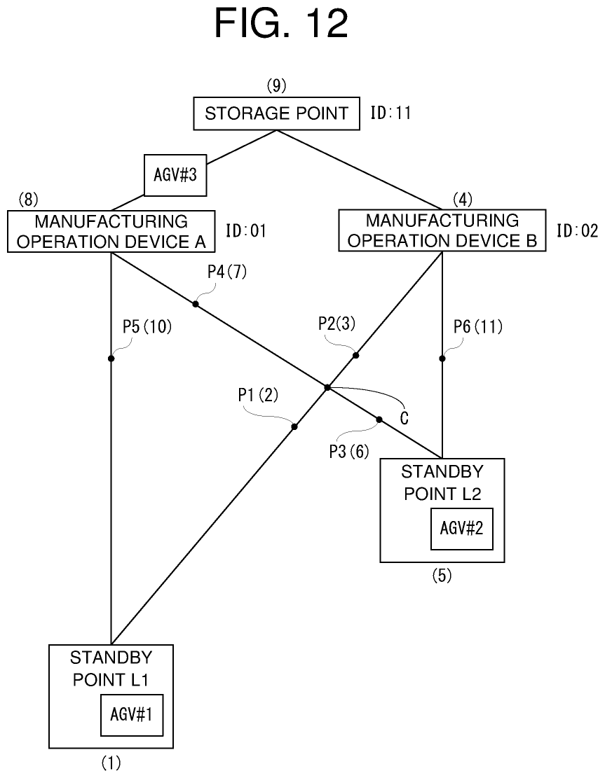

FIG. 12 is a diagram illustrating the map shown in FIG. 7 in a simplified manner. Using FIG. 12, the following describes the arrival time prediction and the vehicle dispatching with respect to the AGVs 20. In FIG. 12, black circles indicate the relay points P1, P2, P3, P4, P5, and P6, and an intersection C. As described above, a parenthesized number is assigned to each of the base positions and the relay points P1 to P6 as location information. In addition, two-digit numbers are respectively assigned to the base position being the transport requester and the base position being the transport destination as the transport requester ID and the transport destination ID.

In examples shown in FIG. 12, the AGV 20 having AGV_ID #1 is on standby at the standby point L1, the AGV 20 having AGV_ID #2 is on standby at the standby point L2, and the AGV 20 having AGV_ID #3 is being transferred from the manufacturing operation device A to the storage point.

Suppose the current date and time is 9:00 and 00 seconds on Apr. 1, 2020. Also suppose on the current date and time, the manufacturing operation device A finishes a manufacturing operation on an in-process item, and then transmits a transport request to the management server 16 to transport this finished in-process item to the storage point. The management server 16 transmits this transport request (referred to below as “current transport request”) to the optimization server 12 and records transport request information on the current transport request in the database 18. Thus, the transport request information is accumulated as the transport request record.

Upon receiving the current transport request, the optimization server 12 observes (or detects) the usage state of all of the AGVs 20 prior to selection of an AGV 20. As described above, the usage state of each AGV 20 means whether the AGV 20 is on standby (not in use) or is in transfer (in use). As described above, each AGV 20 transmits the travel information to the management server 16 at the first predetermined time interval (2 seconds in the present embodiment). The management server 16 records the travel information transmitted from each AGV 20 in the database 18, and the optimization server 12 observes the current position and the usage state of each AGV 20 by referring to the database 18.

In the example shown in FIG. 12, the AGV 20 having AGV_ID #1 is on standby at the standby point L1, the AGV 20 having AGV_ID #2 is on standby at the standby point L2, and the AGV 20 having AGV_ID #3 is being transferred (in use) from the manufacturing operation device A to the storage point.

The optimization server 12 also observes the latest transport request issued by a manufacturing operation device (manufacturing operation device B in this example) other than the manufacturing operation device (manufacturing operation device Ain this example) that has issued the current transport request by referring to the transport request record stored in the database 18.

For example, suppose the optimization server 12 finds that the manufacturing operation device B has issued the latest transport request to transport an in-process item to the storage point at 8:51 and 00 seconds on Apr. 1, 2020. The predicted transport request interval pattern for the manufacturing operation device B is [10002, 02, 600] as shown in FIG. 9. That is, the expected transport request interval value for the manufacturing operation device B is 600 seconds. It is therefore predicted that the manufacturing operation device B is likely to issue the next transport request to transport an in-process item to the storage point at 9:01 and 00 seconds on the same day.

It should be noted that in a case where another manufacturing operation device is provided in addition to the manufacturing operation devices A and B, the same method is used to predict a time at which the manufacturing operation device is likely to issue a transport request in the future.

Generation of Transport Plan (i.e., AGV Allocation Model) Once the time at which the other manufacturing operation device is likely to issue the next transport request has been predicted, allocation models are generated by allocating AGVs 20 to each of the current transport request and the next (future) transport request. In the present embodiment, the next transport request for which the allocation model is generated is a transport request predicted to be issued at a time within a third predetermined time (for example, 600 seconds (10 minutes)) from the current transport request. As such, the two allocation models described below are possible in the present embodiment. It should be noted that any AGVs 20 that are currently in use or that are being recharged are not eligible for the allocation.

Furthermore, in the present embodiment, one of the two allocation models is referred to as an allocation model 1, and the other is referred to as an allocation model 2. The current transport request issued by the manufacturing operation device A at 9:00 and 00 seconds is referred to as a transport request 1, and the next transport request predicted to be issued by the manufacturing operation device B at 9:01 and 00 seconds is referred to as a transport request 2.

In the allocation model 1, the AGV 20 having AGV_ID #1 is allocated to the transport request 1, and the AGV 20 having AGV_ID #2 is allocated to the transport request 2. That is, a candidate AGV 20 is allocated to each of the transport request 1 and the transport request 2. The same applies to the allocation model 2 described below.

In the allocation model 2, the AGV 20 having AGV_ID #1 is allocated to the transport request 2, and the AGV 20 having AGV_ID #2 is allocated to the transport request 1.

Arrival Time Prediction Once a plurality of allocation models have been generated, arrival times are predicted based on the predicted required transfer time patterns. The optimization server 12 predicts arrival times for each of the allocation model 1 and the allocation model 2.

The following first describes the case of the allocation model 1. As described above, it has been observed that the AGV 20 having AGV_ID #1 is on standby at the standby point L1, and the AGV 20 having AGV_ID #2 is on standby at the standby point L2.

In the case of the allocation model 1, therefore, the AGV 20 having AGV_ID #1 needs to be transferred from the standby point L1 to the manufacturing operation device A, and the AGV 20 having AGV_ID #2 needs to be transferred from the standby point L2 to the manufacturing operation device B.

The optimization server 12 refers to the transfer route information included in the master information recorded in the database 18 to acquire a transfer route along which the AGV 20 having AGV_ID #1 is transferred from the standby point L1 to the manufacturing operation device A and location information recorded in association with this transfer route. Likewise, the optimization server 12 refers to the transfer route information included in the master information to acquire a transfer route along which the AGV 20 having AGV_ID #2 is transferred from the standby point L2 to the manufacturing operation device B and location information recorded in association with this transfer route. The location information recorded in association with a transfer route is location information of every base position and every relay point on the transfer route. The same applies to the case of the allocation model 2 described below.

In the present embodiment, as illustrated in FIG. 12, (1)>(10)>(8) is acquired as the transfer route for the AGV 20 having AGV_ID #1, and (5)>(11)>(4) is acquired as the transfer route for the AGV 20 having AGV_ID #2.

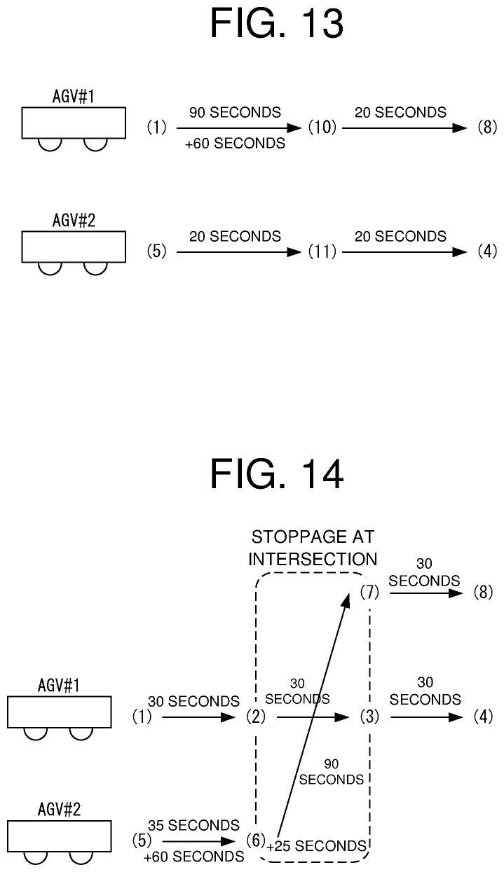

By applying each transfer route to a corresponding one of the predicted required transfer time patterns shown in FIG. 11, the required transfer time for the former transfer route is predicted to be (1)>90 seconds>(10)>20 seconds>(8), and the required transfer time for the latter transfer route is predicted to be (5)>20 seconds>(11)>20 seconds>(4), as shown in FIG. 13. However, taking into account the times of the issuance of the transport requests, the AGV 20 having AGV_ID #1 is expected to start moving 60 seconds later than the AGV 20 having AGV_ID #2 in the case of the allocation model 1. The required transfer time predicted by taking into account the times of the issuance of the transport requests is therefore (1)>150 seconds>(10)>20 seconds>(8).

The transfer route for the AGV 20 having AGV_ID #1 and the transfer route for the AGV 20 having AGV_ID #2 do not intersect with each other in the allocation model 1, and therefore it is not necessary to take into account a stoppage time at the intersection.

In the case of the allocation model 1, an arrival time at which the AGV 20 having AGV_ID #1 is predicted to arrive at the location of the manufacturing operation device A is therefore 9:02 and 50 seconds, which is 170 seconds from the current time. An arrival time at which the AGV 20 having AGV_ID #2 is predicted to arrive at the location of the manufacturing operation device B is 9:00 and 40 seconds, which is 40 seconds from the current time.

The following next describes the case of the allocation model 2. As described above, the AGV 20 having AGV_ID #1 is on standby at the standby point L1, and the AGV 20 having AGV_ID #2 is on standby at the standby point L2. Accordingly, in the case of the allocation model 2, the AGV 20 having AGV_ID #1 needs to be transferred from the standby point L1 to the manufacturing operation device B, and the AGV 20 having AGV_ID #2 needs to be transferred from the standby point L2 to the manufacturing operation device A.

The optimization server 12 refers to the transfer route information included in the master information to acquire a transfer route along which the AGV 20 having AGV_ID #1 is transferred from the standby point L1 to the manufacturing operation device B and location information recorded in association with this transfer route. Likewise, the optimization server 12 refers to the transfer route information included in the master information to acquire a transfer route along which the AGV 20 having AGV_ID #2 is transferred from the standby point L2 to the manufacturing operation device A and location information recorded in association with this transfer route. The location information recorded in association with a transfer route is location information of every base position and every relay point on the transfer route.

In the present embodiment, as illustrated in FIG. 12, (1)>(2)>(3)>(4) is acquired as the transfer route for the AGV 20 having AGV_ID #1, and (5)>(6)>(7)>(8) is acquired as the transfer route for the AGV 20 having AGV_ID #2.

By applying each transfer route to a corresponding one of the predicted required transfer time patterns shown in FIG. 11, the required transfer time for the former transfer route is predicted to be (1)>90 seconds>(2)>30 seconds>(3)>30 seconds>(4), and the required transfer time for the latter transfer route is predicted to be (5)>35 seconds>(6)>90 seconds>(7)>30 seconds>(8), as shown in FIG. 14. However, taking into account the times of the issuance of the transport requests, the AGV 20 having AGV_ID #2 is expected to start moving 60 seconds later than the AGV 20 having AGV_ID #1 in the case of the allocation model 2. The required transfer time predicted by taking into account the times of the issuance of the transport requests is therefore (5)>95 seconds>(6)>90 seconds>(7)>30 seconds>(8).

The optimization server 12 also predicts a stoppage time at the intersection by applying the transfer route for each AGV 20 to the intersection location information and the rules for the intersection action described above. According to the intersection location information, the allocation model 2 has the intersection C where a route (2)>(3) (referred to below as a “partial route”) in the transfer route for the AGV 20 having AGV_ID #1 and a partial route (6)>(7) in the transfer route for the AGV 20 having AGV_ID #2 intersect with each other.

The rules for the intersection action are as described above. That is, an AGV 20 that is traveling one of two partial routes having an intersection and another AGV 20 that has come in the other partial route while the former is traveling are permitted to enter the intersection on a first-come basis. In a case where two AGVs come in their respective partial routes having an intersection at the same time, the AGVs 20 are permitted to enter the intersection in accordance with a priority.

In the case of the allocation model 2, in accordance with the rules for the intersection action described above, the AGV 20 having AGV_ID #1 arrives at the relay point P1 indicated by (2) on the partial route 90 seconds after the transfer start thereof, and arrives at the relay point P2 indicated by (3) on the partial route 120 seconds after the transfer start thereof, exiting the intersection C, as shown in FIG. 14.

By contrast, the AGV 20 having AGV_ID #2 arrives at the relay point P3 indicated by (6) on the partial route 95 seconds after the transfer start thereof, and waits (stops) at the relay point P3 for 25 seconds until the AGV 20 having the AGV_ID #1 has exited the intersection C 120 seconds after the transfer start thereof. The required transfer time predicted for the AGV 20 having AGV_ID #2 by further taking into account the stoppage time is therefore (5)>95 seconds>(6)>115 seconds>(7)>30 seconds>(8).

An arrival time at which the AGV 20 having AGV_ID #1 is predicted to arrive at the location of the manufacturing operation device B in the allocation model 2 is therefore 9:02 and 30 seconds, which is 150 seconds from the current time. An arrival time at which the AGV 20 having AGV_ID #2 is predicted to arrive at the location of the manufacturing operation device A is 9:04 and 00 seconds, which is 240 seconds from the current time.

Selection of Allocation Model Once the arrival times of the respective AGVs 20 have been predicted for each allocation model, one allocation model is selected from the plurality of allocation models based on a predetermined condition, and a transfer instruction for responding to the current transport request is generated in accordance with the selected allocation model. That is, an AGV 20 to accommodate the current transport request is determined (or dispatched).

In the present embodiment, the predetermined condition is a smaller evaluation value. The evaluation value is, for example, a total of the times required for the AGVs 20 to move from the respective starting points to the respective finishing points. Each required time is from the current time to the time at which the AGV 20 is predicted to arrive at the finishing point, which is determined by taking into account the time of the issuance of the corresponding transport request and the stoppage time as well as the required transfer time.

In the case of the allocation model 1, the required time for the AGV 20 having AGV_ID #1 is 170 seconds, and the required time for the AGV 20 having AGV_ID #2 is 40 seconds from the current time. Accordingly, the total thereof is 210 seconds.

In the case of the allocation model 2, the required time for the AGV 20 having AGV_ID #1 is 150 seconds, and the required time for the AGV 20 having AGV_ID #2 is 240 seconds. Accordingly, the total thereof is 390 seconds.

Consequently, in accordance with the predetermined condition, the allocation model 1 is selected. Accordingly, the optimization server 12 determines the AGV 20 having AGV_ID #1 as the AGV 20 to accommodate the current transport request, determines (1)>(8) ((1)>(10)>(8)) as the transfer route, and transmits, to the management server 16, a transfer instruction including travel parameters determined based on the determined transfer route. The management server 16 transmits the transfer instruction received from the optimization server 12 to the AGV 20 having an AGV_ID included in the transfer instruction (referred to below also as a “target AGV 20”). Technically, the management server 16 transmits (broadcasts) the transfer instruction to the additional network, and the AGV 20 that has received the transfer instruction determines whether or not the AGV_ID included in the transfer instruction matches its own AGV_ID and starts moving in accordance with the transfer instruction upon determining such a match. The management server 16 also adds the transfer instruction to the transfer instruction record in the database 18.

The management server 16 also records (or accumulates), in the database 18, the travel information transmitted by each AGV 20 at the first predetermined time interval.

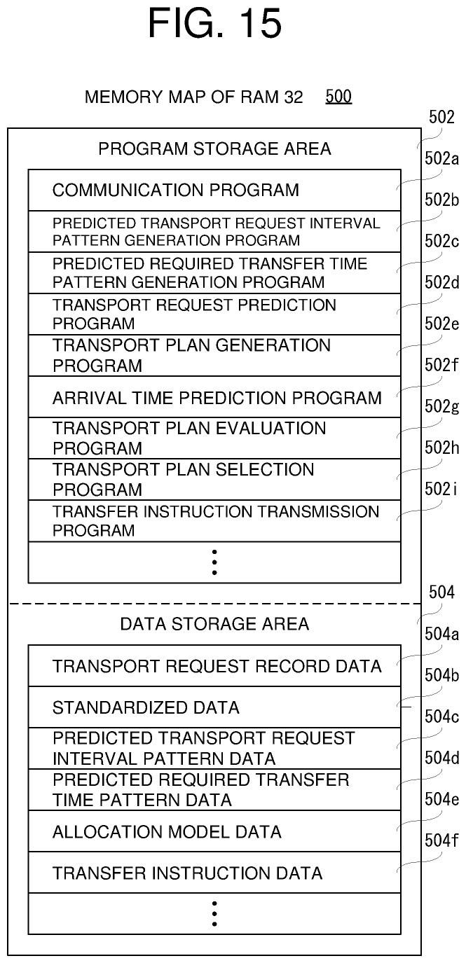

FIG. 15 is a diagram illustrating an example of a memory map 500 of the RAM 32 included in the optimization server 12 illustrated in FIG. 2. As shown in FIG. 15, the RAM 32 includes a program storage area 502 and a data storage area 504.

In the program storage area 502, programs (information processing programs) to be executed by the CPU 30 in the optimization server 12 are stored. The information processing programs include, for example, a communication program 502a, a predicted transport request interval pattern generation program 502b, a predicted required transfer time pattern generation program 502c, a transport request prediction program 502d, a transport plan generation program 502e, an arrival time prediction program 502f, a transport plan evaluation program 502g, a transport plan selection program 502h, and a transfer instruction transmission program 502i.

The communication program 502a is executed for communication with computers or other devices such as the management server 16 and the database 18 using the communication device 34.

The predicted transport request interval pattern generation program 502b is executed for generating the predicted transport request interval patterns by the LSTM method based on the transport request record. The predicted required transfer time pattern generation program 502c is executed for generating the predicted required transfer time patterns through patterning by the Gaussian process based on the accumulated standardized information (standardized data 504b described below).

The transport request prediction program 502d is executed for predicting, upon the current transport request being issued by a manufacturing operation device, the next transport request that is likely to be issued in the future by any other manufacturing operation device by referring to the predicted transport request interval patterns.

The transport plan generation program 502e is executed for generating a plurality of allocation models by allocating different candidate AGVs 20 to each of the current transport request and the next transport request.

The arrival time prediction program 502f is executed for predicting an arrival time at which each AGV 20 is likely to arrive at the finishing point for each of the plurality of allocation models generated through the transport plan generation program 502e.

The transport plan evaluation program 502g is executed for calculating an evaluation value for each of the plurality of allocation models for which the arrival times have been predicted through the arrival time prediction program 502f.

The transport plan selection program 502h is executed for selecting one allocation model from the plurality of allocation models based on the evaluation values calculated through the transport plan evaluation program 502g.

The transfer instruction transmission program 502i is executed for generating a transfer instruction (transfer instruction data 504g described below) for responding to the current transport request based on the one allocation model selected through the transport plan selection program 502h, and transmitting the transfer instruction to the management server 16. The communication program 502a is also executed when the transfer instruction is transmitted to the management server 16.

It should be noted that in the program storage area 502, other programs necessary for the execution of the information processing programs are also stored.

In the data storage area 504, for example, transport request record data 504a, the standardized data 504b, predicted transport request interval pattern data 504c, predicted required transfer time pattern data 504d, allocation model data 504e, and the transfer instruction data 504f are stored.

The transport request record data 504a is data on the transport request record obtained by accumulating transport requests issued by the manufacturing operation devices in chronological order. The standardized data 504b is data obtained by accumulating standardized information generated based on the travel information acquired from each AGV 20 at the first predetermined time interval.

The predicted transport request interval pattern data 504c is data on the predicted transport request interval patterns generated through the predicted transport request interval pattern generation program 502b using the transport request record data 504a.

The predicted required transfer time pattern data 504d is data on the predicted required transfer time patterns generated through the predicted required transfer time pattern generation program 502c using the standardized data 504b.

The allocation model data 504e is data on the plurality of allocation models generated through the transport plan generation program 502e.

The transfer instruction data 504f is data on the transfer instruction generated for responding to the current transport request based on the one allocation model selected through the transport plan selection program 502h, and includes the AGV_ID of a target AGV 20, a transfer route, and travel parameters.

It should be noted that in the data storage area 504, other data necessary for the execution of the information processing programs is stored, and a timer (counter) and a flag necessary for the execution of the information processing programs are provided.

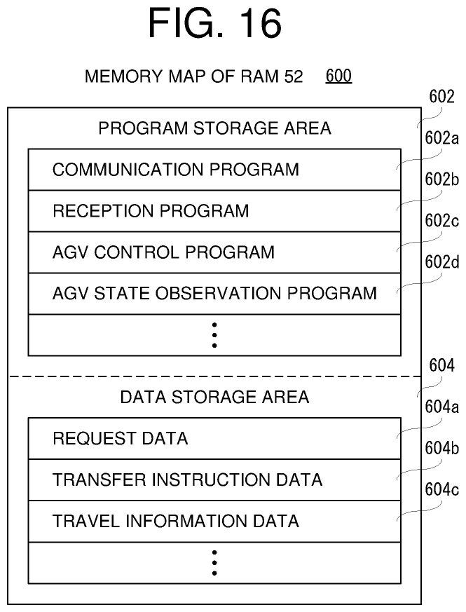

FIG. 16 is a diagram illustrating an example of a memory map 600 of the RAM 52 included in the management server 16 illustrated in FIG. 3. As shown in FIG. 16, the RAM 52 includes a program storage area 602 and a data storage area 604.

In the program storage area 602, programs (management programs) to be executed by the CPU 50 in the management server 16 are stored. The management programs include, for example, a communication program 602a, a reception program 602b, an AGV control program 602c, and an AGV state observation program 602d.

The communication program 602a is executed for communication with computers or other devices such as the AGVs 20 using the first communication device 54. In some cases, communication is established via an access point. The communication program 602a is also executed for making notifications to computers or other devices such as the optimization server 12 and the database 18 using the second communication device 56.

The reception program 602b is executed for receiving transport requests. The reception program 602b is also executed for recording, upon receiving a transport request, the received transport request in the database 18. At the same time, the communication program 602a is also executed.

The AGV control program 602c is executed for specifying an AGV 20 to be controlled and for transmitting, to the AGV 20, the transfer instruction, which includes the determined transfer route and the selected travel parameters, and an action instruction, which indicates a predetermined action. Upon the optimization server 12 receiving the transfer instruction data 504g, the received transfer instruction data 504g is transmitted to the additional network.

The AGV state observation program 602d is executed for observing the travel information for each of one or more AGVs 20 in use for transport among the plurality of AGVs 20 residing in the factory. Specifically, the travel information of the AGVs 20, which is transmitted from each AGV 20 at the first predetermined time interval, is received, stored in the RAM 52, and stored (recorded) in the database 18.

It should be noted that in the program storage area 602, other programs necessary for the execution of the management programs are also stored. For example, a program is stored for temporarily stopping a traveling AGV 20 (referred to as a “target AGV 20” for the sake of explanation) in a case where another AGV 20 is being stopped in front of the target AGV 20 or another AGV 20 has entered an intersection the target AGV 20 is about to enter.

In the data storage area 604, request data 604a, transfer instruction data 604b, and travel information data 604c are stored.

The request data 604a is data on a transport request from a manufacturing operation device, which in other words is one of the computers 22, in the factory. In a case where two or more of the computers 22 issue transport requests at the same time or in the same time period, the request data 604a is data on the plurality of transport requests.

The transfer instruction data 604b is data on a transfer instruction generated for responding to a transport request or received from the optimization server 12. The travel information data 604c is data on the travel information transmitted from each AGV 20 at the first predetermined time interval.

It should be noted that in the data storage area 604, other data necessary for the execution of the management programs is stored, and a timer (counter) and a flag necessary for the execution of the management programs are provided.

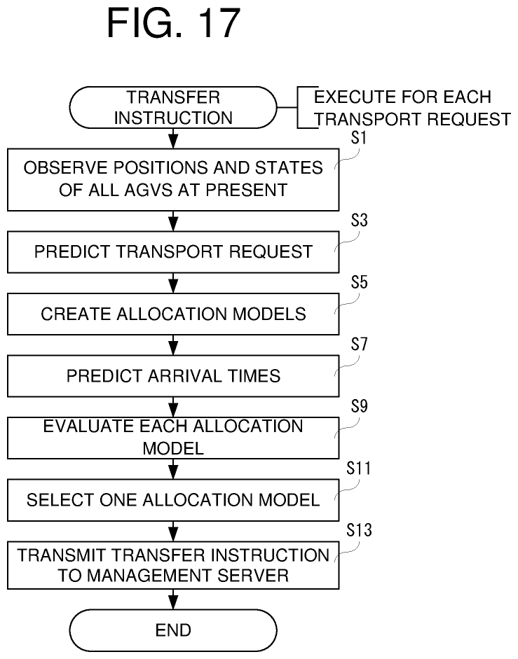

FIG. 17 is a flow chart showing a transfer instruction process as an example of information processing to be performed by the CPU 30 incorporated in the optimization server 12 illustrated in FIG. 2. It should be noted that the transfer instruction process shown in FIG. 17 is performed each time a transport request (current transport request) is issued. As shown in FIG. 17, upon a transport request being issued by a manufacturing operation device, the CPU 30 starts the transfer instruction process, and observes current positions and usage states (on standby or in transfer) of all of the AGVs 20 by referring to the database 18 in step S1.

Next, in step S3, the CPU 30 predicts another transport request. In the present embodiment, the CPU 30 predicts a transport request that is likely to be issued in the future by another manufacturing operation device different from the manufacturing operation device that has issued the current transport request, using the predicted transport request interval patterns.

Next, in step S5, the CPU 30 creates a plurality of allocation models. In the present embodiment, the CPU 30 generates a plurality of allocation models by acquiring, from the transfer route information included in the master information stored in the database 18, a plurality of transfer routes to which available AGVs 20 are allocated in different patterns for each of the current transport request and the predicted transport request.

Next, in step S7, the CPU 30 predicts arrival times. In the present embodiment, the CPU 30 predicts arrival times by predicting required transfer times for the respective AGVs 20 in each of the allocation models using the predicted required transfer time patterns, and taking into account times of the issuance of the transport requests and a delay time due to congestion.

Next, in step S9, the CPU 30 evaluates each of the allocation models. In the present embodiment, the CPU 30 calculates, for each of the allocation models, a total (evaluation value) of the required transfer times for the respective AGVs 20.

Next, in step S11, the CPU 30 selects one of the allocation models based on the evaluation values. Then, in step S13, the CPU 30 generates the transfer instruction data 504g on a transfer instruction for responding to the current transport request based on the one allocation model selected in step S11, transmits the thus generated transfer instruction data 504g to the management server 16, and ends the transfer instruction process.

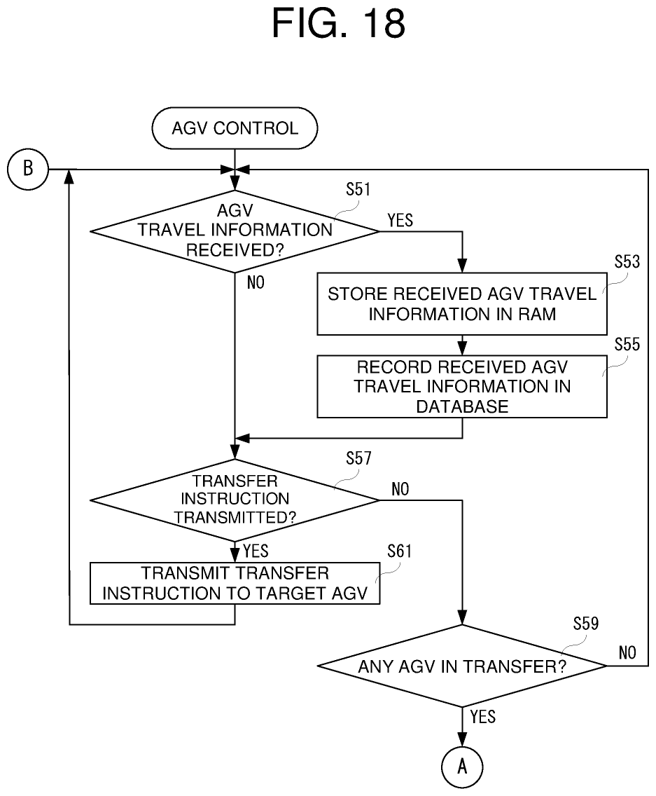

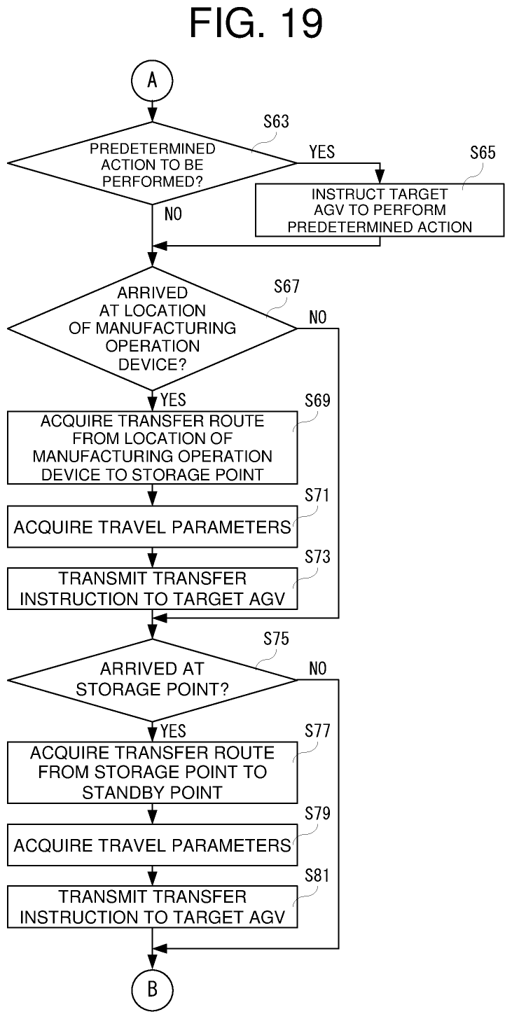

FIGS. 18 and 19 are flow charts showing an example of an AGV control process to be executed by the CPU 50 incorporated in the management server 16 illustrated in FIG. 3. This AGV control process is performed when the optimization server 12 transmits a transfer instruction in response to a transport request.

As shown in FIG. 18, upon starting the AGV control process, the CPU 50 in the management server 16 determines, in step S51, whether or not the travel information of any of the AGVs 20 has been received.

If “NO” in step S51, that is, if the travel information of any of the AGVs 20 has not been received, the process advances to step S57. If “YES” in step S51, that is, if the travel information of any of the AGVs 20 has been received, the CPU 50 stores (updates with) the received travel information of the AGVs 20 in step S53, and records the received travel information of the AGVs 20 in the database 18 in step S55. The process then advances to step S57. In step S53, the CPU 50 updates the travel information data 604c. In step S55, the CPU 50 updates the history of the travel information recorded in the database 18.

In step S57, the CPU 50 determines whether or not a transfer instruction has been transmitted from the optimization server 12. Specifically, the CPU 50 determines whether or not the transfer instruction data 504g has been received and whether or not the transfer instruction data 504g has been stored in the data storage area 604 as the transfer instruction data 604b.

If “NO” in step S57, that is, if no transfer instruction has been transmitted from the optimization server 12, the CPU 50 determines whether or not any of the AGVs 20 is in transfer in step S59. The term “in transfer” as used herein encompasses not only a state of the AGV 20 actually transporting an item but also a state of the AGV 20 moving toward a manufacturing operation device to be loaded with an item and a state of the AGV 20 moving to return to the standby point thereof after having transported an item to a transport destination.

If “NO” in step S59, that is, if no AGV 20 is in transfer, the process returns to step S51. If “YES” in step S59, that is, if any of the AGVs 20 is in transfer, the process advances to step S63 shown in FIG. 19.

If “YES” in step S57, that is, if a transfer instruction has been transmitted from the optimization server 12, the CPU 50 transmits the transfer instruction data 604b to the target AGV 20 in step S61. The process then returns to step S51. Consequently, the target AGV 20 that has received the transfer instruction data 604b starts moving along the transfer route indicated by the transfer instruction data 604b using the travel parameters indicated by the transfer instruction data 604b.

In step S63, as shown in FIG. 19, the CPU 50 determines whether or not a predetermined action is to be performed. In the present embodiment, the CPU 50 determines whether or not the target AGV 20 has arrived at a location at which the target AGV 20 is to travel straight ahead, travel backward, stop, move over to the left, move over to the right, turn left, turn right, or change speed. If “NO” in step S63, that is, if no predetermined action is to be performed, the process advances to step S67. If “YES” in step S63, that is, if a predetermined action is to be performed, the CPU 50 instructs the target AGV 20 to perform the predetermined action in step S65. The process then advances to step S67.

In step S67, the CPU 50 determines whether or not the AGV 20 has arrived at the location of the manufacturing operation device (i.e., requester of the transport request). If “NO” in step S67, that is, if the AGV 20 has not arrived at the location of the manufacturing operation device, the process advances to step S75. If “YES” in step S67, that is, if the AGV 20 has arrived at the location of the manufacturing operation device, the CPU 50 acquires, from the master information in the database 18, a transfer route from the location of the manufacturing operation device to a storage point in step S69. The CPU 50 then acquires the travel parameters corresponding to the transfer route from the master information in the database 18 in step S71. The CPU 50 then transmits a transfer instruction including the acquired transfer route and the acquired travel parameters to the target AGV 20 in step S73. The process then advances to step S75.

It should be noted that upon receiving the transfer instruction indicating the transfer from the location of the manufacturing operation device to the storage point, the AGV 20 starts moving (i.e., transporting) after coupling the towing arms 26 thereof to a cart.

In step S75, the CPU 50 determines whether or not the target AGV 20 has arrived at the storage point. If “NO” in step S75, that is, if the target AGV 20 has not arrived at the storage point, the process returns to step S51.

If “YES” in step S75, that is, if the AGV 20 has arrived at the storage point, the CPU 50 acquires, from the master information, a transfer route from the storage point to a standby point (standby point L1 or L2 in the present embodiment) in step S77. The CPU 50 then acquires travel parameters corresponding to the transfer route from the master information in step S79. The CPU 50 then transmits a transfer instruction including the acquired transfer route and the acquired travel parameters to the target AGV 20 in step S81. The process then returns to step S51.

It should be noted that upon receiving the transfer instruction indicating the transfer from the storage point to the standby point, the AGV 20 starts moving after releasing the cart from the towing arms 26 thereof.

The process including steps S57 to S81 is performed on the AGVs 20 under travel control by the system 10 on a per-AGV 20 basis. In the AGV control process shown in FIGS. 18 and 19, the CPU 50 acquires, from the master information, the transfer route from the location of the manufacturing operation device to the storage point when the AGV 20 is at the location of the manufacturing operation device, and the transfer route from the storage point to the standby point when the AGV 20 is at the storage point. However, the CPU 50 may alternatively acquire these transfer routes from the master information when the optimization server 12 has transmitted the transfer instruction. The same applies to the travel parameters.

According to the present embodiment, the predicted required transfer time patterns generated based on the transfer record including the past transfers are used for prediction of required transfer times. It is therefore possible to predict arrival times with high accuracy.

Furthermore, according to the present embodiment, required transfer times for transfers from standby points to manufacturing operation devices are predicted using the predicted required transfer time patterns for each of a plurality of allocation models generated by allocating AGVs to transfer routes in different patterns. In addition to that, times of the issuance of transport requests and a delay time due to congestion are taken into account. It is therefore possible to predict arrival times with higher accuracy.

Furthermore, according to the present embodiment, the predicted transport request interval patterns generated based on the transport request record including the past transport requests are used. When a manufacturing operation device issues the current transport request, therefore, it is possible to predict a time at which the next transport request is likely to be issued by another manufacturing operation device. This makes it possible to dispatch an AGV 20 by taking into account a plurality of transport requests including a future transport request.

According to the present embodiment, an AGV is dispatched by taking into account a plurality of transport requests including a future transport request. It is therefore possible to reduce waste of time and power consumed by AGVs in terms of an overall transport operation.

In the embodiment described above, when a manufacturing operation device issues a transport request, a transport request that is likely to be issued in the future by another manufacturing operation device is predicted using the predicted transport request interval patterns, and the predicted transport request interval patterns include expected transport request interval values (seconds). However, the present invention is not limited as such. The predicted transport request interval patterns may include a plurality of expected transport request time values (hour, minute, second) instead of the expected transport request interval values. In this case, it is possible to directly know a transport request time at which the transport request is likely to be issued in the future.

In the embodiment described above, arrival times of AGVs are predicted by taking into account times of the issuance of transport requests and a delay time due to congestion. However, the travel information includes an error, and therefore each of the arrival times may be predicted by further taking into account a delay time due to such an error. In this case, such an error-caused delay time is predicted by applying the corresponding transfer route to expected error-caused delay time values, and the predicted error-caused delay time is added to the required transfer time when the arrival time is predicted.

Although not mentioned in the embodiment described above, transport requests and the travel information are recorded in the database even after the predicted transport request interval patterns and the predicted required transfer time patterns have been generated. The predicted transport request interval patterns and the predicted required transfer time patterns may therefore be regenerated at a predetermined time interval (for example, once a month). In this case, it is possible to generate appropriate predicted patterns responding to changes in the usage environment. That is, it is possible to predict highly accurate arrival times responding to changes in the usage environment, allowing for appropriate AGV dispatching.

In the present embodiment, the evaluation value for each allocation model is calculated by adding up required transfer times predicted by taking into account times of the issuance of transport requests and a delay time due to congestion. However, the present invention is not limited as such.

In another embodiment, the evaluation value may be calculated by further adding the delay time due to congestion to the sum of the required transfer times predicted by taking into account the times of the issuance of the transport requests and the delay time due to congestion. As in the case of the forgoing embodiment, an allocation model having a smaller evaluation value is selected. The same applies to other embodiments.

In still another embodiment, the evaluation value may be calculated by further taking into account power consumption in addition to the sum of the required transfer times. In this case, the amount of power to be consumed is added to the sum of the required transfer times. The amount of power to be consumed is predicted (or calculated) by applying the transfer routes to expected values of the amount of power to be consumed by the batteries incorporated in the respective AGVs. These expected values are generated through patterning based on the travel information.

In the embodiment described above, the management server acquires transfer routes and travel parameters from the master information stored in the database. Alternatively, the transfer routes and the travel parameters may be stored in the management server.

Furthermore, the specific configuration of the system and the AGVs in the embodiment described above can be changed as appropriate in actual products.

For example, each AGV may be configured to carry an item thereon instead of towing a cart. In this case, a load sensor capable of measuring load of the item carried on the AGV is used.

In the embodiment described above, the optimization server and the management server are separately provided. Alternatively, a single server having functions of these two servers may be adopted. Furthermore, the database may be incorporated in the optimization server or the management server.

What is claimed is:

1. A required transfer time prediction device comprising:
a plurality of automatic guided vehicles;
a transfer instruction device that transmits, in response to transport requests issued from a plurality of requesters, transfer instructions to the plurality of automatic guided vehicles;
a transfer information recorder that records a plurality of pieces of transfer information including transfer routes and required transfer times of the plurality of automatic guided vehicles that have been transferred in response to the transfer instructions; and
a required transfer time predictor that predicts required transfer times for the respective automatic guided vehicles to be transferred along transfer routes based on the transfer instructions, wherein the required transfer time predictor predicts, upon receiving a current transport request issued from one of the requesters, the required transfer times using predicted required transfer time patterns generated through patterning based on the transfer information recorded by the transfer information recorder.

2. The required transfer time prediction device according to claim 1, wherein the required transfer time predictor selects, upon receiving a current transport request from one of the requestors, one of the plurality of automatic guided vehicles, determines a transfer route along which the selected one automatic guided vehicle is transferred from a current position thereof to a transfer destination, and predicts the required transfer time by applying the transfer route to the predicted required transfer time patterns.

3. The required transfer time prediction device according to claim 1, wherein the predicted required transfer time patterns include information of expected required transfer time values for the automatic guided vehicles, the expected required transfer time values being expected for each of the plurality of recorded transfer routes.

4. The required transfer time prediction device according to claim 3, wherein
each of the recorded transfer routes includes one of a plurality of recorded locations as a recorded transfer route starting point and another one of the plurality of recorded locations as a recorded transfer route finishing point, and
in a case where any of the transfer routes has a plurality of recorded locations thereon, the required transfer time predictor allocates, to the transfer route, one or more of the recorded transfer routes each having one of the plurality of recorded locations on the transfer route as the recorded transfer route starting point and another one of the plurality of recorded locations on the transfer route as the recorded transfer route finishing point, and calculates, as the required transfer time, a sum of expected required transfer time values for the automatic guided vehicles corresponding to the respective one or more recorded transfer routes allocated.

5. The required transfer time prediction device according to claim 3, wherein the required transfer time predictor calculates a delay time for each of the transfers of the automatic guided vehicles along the recorded transfer routes by referring to transfer rule information corresponding to the recorded transfer route.

6. The required transfer time prediction device according to claim 5, wherein
the transfer rule information includes intersection waiting rule information for a case where two or more of the automatic guided vehicles simultaneously arrive at an intersection where at least portions of two or more of the recorded transfer routes overlap or intersect with each other, and
the required transfer time predictor determines whether or not two or more of the automatic guided vehicles simultaneously arrive at an intersection by predicting the required transfer times for the respective two or more automatic guided vehicles, and calculates, upon determining that two or more of the automatic guided vehicles simultaneously arrive at an intersection, a waiting time of any of the two or more automatic guided vehicles at the intersection as the delay time based on the intersection waiting rule information, as the delay time.

7. The required transfer time prediction device according to claim 1, further comprising:
a transport request recorder that stores a plurality of pieces of transport request information including the transport requests issued from the plurality of requesters, and date and time of the issuance of each of the transport requests; and
a transport request predictor that predicts, upon receiving a current transport request issued from one of the requesters, one or more future transport requests that are likely to be issued in the future from one or more other requesters, using predicted transport request time patterns or predicted transport request interval patterns generated through patterning based on the plurality of pieces of transport request information stored by the transport request recorder, wherein the required transfer time predictor further predicts required transfer times for the respective automatic guided vehicles to be transferred along transfer routes based on the one or more future transport requests.

8. The required transfer time prediction device according to claim 7, further comprising an allocation determiner that determines allocation of one of the plurality of automatic guided vehicles to each of the current transport request and the one or more future transport requests, by taking into account the current transport request and the one or more future transport requests, wherein
the allocation determiner includes: an allocator that generates a plurality of allocation models by allocating, in different combinations or in different allocation patterns, candidate automatic guided vehicles among the plurality of automatic guided vehicles to transfer routes for each of the current transport request and the one or more future transport requests;
an evaluation value calculator that calculates an evaluation value for each of the plurality of allocation models generated by the allocator; and
a selector that selects one of the allocation models based on the plurality of evaluation values calculated by the evaluation value calculator.

9. The required transfer time prediction device according to claim 8, wherein the allocation determiner further includes: a modifier that modifies the required transfer times predicted by the required transfer time predictor for each of the plurality of allocation models generated by the allocator, by taking into account times of the issuance of the transport requests and a delay time; and
an arrival time predictor that predicts arrival times of the respective automatic guided vehicles for each of the plurality of allocation models generated by the allocator, using the required transfer times modified by the modifier.

10. The required transfer time prediction device according to claim 8, wherein the evaluation value is a sum of the required transfer times.

11. The required transfer time prediction device according to claim 9, wherein the evaluation value is a sum of the required transfer times modified by the modifier and the delay time.

12. The required transfer time prediction device according to claim 7, wherein the predicted transport request time patterns or the predicted transport request interval patterns are generated through patterning, by a long short-term memory method, of the plurality of pieces of transport request information stored by the transport request recorder.

13. The required transfer time prediction device according to claim 1, wherein the predicted required transfer time patterns are generated through patterning, by a Gaussian process, of the plurality of pieces of transfer information recorded by the transfer information recorder.

14. A required transfer time prediction method comprising:
transmitting, in response to transport requests issued from a plurality of requesters, transfer instructions to a plurality of automatic guided vehicles;
recording, in a storage medium, a plurality of pieces of transfer information including transfer routes and required transfer times of the plurality of automatic guided vehicles that have been transferred in response to the transfer instructions; and
predicting required transfer times for the respective automatic guided vehicles to be transferred along transfer routes based on the transfer instructions, wherein the predicting required transfer times including predicting, upon a current transport request being issued from one of the requesters, the required transfer times using predicted required transfer time patterns generated through patterning based on the recorded transfer information.
